(19) United States
(12) Patent Application Publication
(10) Pub. No.: US 2026/0165248 A1
(43) Pub. Date: Jun. 18, 2026

(54) FORCED AIRFLOW COTTON CONVEYING SYSTEM FOR A COTTON HARVESTER

(71) Applicant: Deere & Company, Moline, IL (US)

(72) Inventors: Daniel J. Johannsen, Des Moines, IA (US); Shubham Dubey, Pune (IN); Devesh Sharma, Pune (IN); Shrikant S. Sadavarte, Pune (IN); Amol Sawale, Pune (IN); Vrushali R. Pisal, Pune (IN); Sanjeev M. Hallale, Pune (IN); Justin E. Hummel, Des Moines, IA (US)

(73) Assignee: Deere & Company, Moline, IL (US)

(21) Appl. No.: 19/391,523

(22) Filed: Nov. 17, 2025

Related U.S. Application Data
(60) Provisional application No. 63/733,621, filed on Dec. 13, 2024.

(51) Int. Cl. A01D 57/00; A01D 46/08

(52) U.S. Cl. CPC A01D 57/00; A01D 46/08

(57) ABSTRACT

A forced airflow cotton conveying system includes a cotton picking unit, an air duct that provides an airtight seal between the cotton picking unit and a cotton crop storage receptacle, an airflow generator operable to generate an airflow, and first and second nozzles. The first nozzle forms a first airflow path generating a first suction airflow within the cotton picking unit and a first forced airflow within the first air duct. The second nozzle forms a second airflow path generating a second suction airflow within the cotton picking unit and a second forced airflow within the first air duct. The first and second forced airflows combine within the air duct to convey cotton harvested by the cotton picking unit to the crop storage receptacle and may optionally combine with a supplemental boost airflow to help propel the cotton within the duct system under positive pressure and without creating a vacuum.

### CROSS-REFERENCE TO RELATED APPLICATION

The present application is based on and claims the benefit of U.S. Provisional Patent application Ser. No. 63/733,621, filed Dec. 13, 2024, entitled FORCED AIRFLOW SYSTEM FOR A COTTON HARVESTER, Docket Number (016529-000247/P35961-US-PRO), the contents of which is hereby incorporated by reference herein in its entirety.

### FIELD

The present disclosure relates to cotton handling during harvesting and, more particularly, to apparatus and methods using forced air to convey cotton from a cotton harvesting unit of a cotton harvester to a crop storage receptacle such as an accumulator or basket of the cotton harvester.

### BACKGROUND

Harvesters have been used to harvest different crops. When using a cotton harvester to harvest cotton, individual picker row units carry spindles which remove cotton from rows of cotton plants, and doffer assemblies doff the cotton from the spindles. The doffed cotton may drop downwardly through a free fall zone to a cotton-receiving suction opening at the lower end of a discharge compartment of the row unit. A duct extends upwardly from the discharge opening and connects the discharge compartment with a cotton receptacle on the harvester. A stream of air directed upwardly into the duct at a location downstream of the cotton-receiving suction opening creates a vacuum at the opening and induces a draft in the compartment. The cotton is essentially sucked through the opening and upwardly into the duct to the airstream location. The cotton is then blown into the receptacle by the airstream.

Some harvesters have been provided with one or more supplemental nozzles in addition to main or primary suction nozzle ends used in the ducts to generate the vacuum at the opening of the individual picker row units, wherein the supplemental nozzles are used for directing forced air into various lower regions of the multiple harvester picker units for helping to discourage the occurrence of cotton stagnating within areas of the picker units as the cotton is harvested. The forced air from the supplemental nozzles causes localized agitation of the cotton within the confines of the picker units that, in combination with the suction flow generated within the air duct system drawing the cotton from the multiple picker units, has helped with reducing stagnation of the cotton within the picker units. Overall however, the use of a suction-type airflow flow as the main or primary source of motivating the harvested cotton to flow from the picker units to areas adjacent to the primary suction nozzles ends in the ducts, and then eventually to flow under pressure from the primary suction nozzle ends to the selected area of the harvester has been somewhat inefficient.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more systems, techniques, and methods are described herein for harvesting cotton crops with higher efficiency and throughput using one or more forced airflows. In the implementations herein, one or more forced airflows is/are used exclusively to convey or otherwise cause movement of harvested cotton crops, wherein the one or more forced airflows is/are one or more streams of air directed into picker row units and/or into ducts of a cotton harvester without the creation of vacuum region(s). The one or more forced airflows of the implementations herein are, essentially, one or more streams of air that maintain at all regions of the picker row units and/or ducts of the cotton harvester downstream of the one or more streams of air, a pressure of one (1) atmosphere (atm) or above 1 atm.

In one implementation, a forced airflow cotton conveying system for a cotton harvester comprises an air source and one or more nozzles having nozzle inlets configured to receive air from the air source and one or more nozzle ends defining nozzle outlets disposed in a cotton picking row unit and configured to direct airflow pushing harvested cotton away from the cotton picking row unit and into a duct system for conveying the harvested cotton to a cotton storage receptacle of the harvester vehicle such as for example towards or into an accumulator or basket harvester vehicle. The forced airflow cotton conveying system further comprises one or more ducts coupling the one or more nozzles to the air source to form an air path therethrough, wherein the one or more nozzle outlets defined by the nozzle ends are disposed adjacent to the doffers of the cotton harvesting units to direct the airflow to define a positive airflow exiting the cotton harvesting units for carrying the cotton to the cotton storage receptacle of the harvester vehicle via air ducts using the positive air flow.

In a further implementation, a forced airflow cotton conveying system for a cotton harvester comprises an air source and one or more nozzles having nozzle inlets configured to receive air from the air source, one or more nozzle ends defining nozzle outlets disposed in a cotton picking row unit and configured to direct airflow pushing cotton away from the cotton harvesting unit and into a duct system. The cotton conveying system further comprises one or more ducts coupling the one or more nozzles to the air source to form an air path therethrough, wherein the one or more nozzle outlets defined by the nozzle ends are disposed adjacent to the doffers of the cotton harvesting units to direct the airflow to define a positive airflow exiting the cotton harvesting units that, selectively together with an optional supplemental boost airflow, carry the cotton to the cotton storage receptacle of the harvester vehicle via the air ducts using the positive air flows.

In any of the implementations, the forced airflow cotton conveying system includes one or more cotton flow accelerators configured to receive air from the air source and having one or more boost nozzle end outlets opening in the duct system to selectively direct the supplemental boost airflow pushing the cotton within the duct system to help propel the cotton within the duct system towards the cotton storage receptacle using pressure of the supplemental boost airflow within the duct system.

In any of the implementations, the first and second airflows collectively comprise a range of 60%-100% of the airflow within the first air duct flowing to the crop storage receptacle of the cotton harvester, and the supplemental boost airflow comprises a corresponding range of 40% 0% of the airflow within the first air duct flowing from the one or more cotton flow accelerators and optionally from the one or more cotton flow accelerators to the crop storage receptacle of the cotton harvester.

In any of the implementations, the first and second airflows collectively comprise 74% of the airflow within the first air duct flowing to the crop storage receptacle of the cotton harvester, and the supplemental boost airflow comprises 26% of the airflow within the first air duct flowing from the one or more cotton flow accelerators to the crop storage receptacle of the cotton harvester.

In any of the implementations, the first and second nozzles define nozzle openings that collectively define a nozzle airflow outlet area, and the one or more cotton flow accelerators collectively define a cotton flow accelerator outlet area.

In any of the implementations, the nozzle airflow outlet area comprises a range of 60%-100% of the combined area defined by the nozzle airflow outlet area together with the cotton flow accelerator outlet area, and the cotton flow accelerator outlet area comprises a corresponding range of 40%-0% of the combined area defined by the nozzle airflow outlet area together with the cotton flow accelerator outlet area.

In any of the implementations, the nozzle airflow outlet area comprises 74% of the combined area defined by the nozzle airflow outlet area together with the cotton flow accelerator outlet area, and the cotton flow accelerator outlet area comprises a corresponding 26% of the combined area defined by the nozzle airflow outlet area together with the cotton flow accelerator outlet area.

In a further implementation, a boosted forced airflow cotton conveying system for a cotton harvester comprises an air source and one or more nozzles having nozzle inlets configured to receive air from the air source, one or more nozzle ends defining nozzle outlets disposed in a cotton picking row unit and configured to direct airflow pushing cotton away from the cotton harvesting unit and into a duct system, and one or more cotton flow accelerators configured to receive air from the air source and having one or more boost nozzle end outlets opening in the duct system to direct a supplemental boost airflow pushing the cotton within the duct system to help propel the cotton within the duct system towards the cotton storage receptacle using pressure of the supplemental boost airflow within the duct system. The boosted cotton conveying system further comprises one or more ducts coupling the one or more nozzles to the air source to form an air path therethrough, wherein the one or more nozzle outlets defined by the nozzle ends are disposed adjacent to the doffers of the cotton harvesting units to direct the airflow to define a positive airflow exiting the cotton harvesting units that, together with the supplemental boost airflow, carry the cotton to the cotton storage receptacle of the harvester vehicle via the air ducts using the positive air flows.

In the implementations herein apparatus and methods are provided using forced air without any generated suction force or forces to convey cotton from a cotton harvesting unit of a cotton harvester to a cotton storage receptacle of the harvester vehicle via one or more cotton conveying ducts or the like.

In the implementations herein apparatus and methods are provided using forced air exclusively to convey cotton from a cotton harvesting unit of a cotton harvester to a cotton storage receptacle of the harvester vehicle via one or more cotton conveying ducts or the like.

In the implementations herein apparatus and methods are provided using forced air exclusively without any generated suction force or forces to convey cotton from a cotton harvesting unit of a cotton harvester to a cotton storage receptacle of the harvester vehicle via one or more cotton conveying ducts or the like.

In an implementation a method is provided for use with an associated cotton harvester for conveying cotton, wherein the method includes conveying cotton harvested by a cotton picking unit of the associated cotton harvester to a crop storage receptacle of the associated cotton harvester using a forced airflow generated by an airflow generator of the associated cotton harvester.

In an implementation a method is provided for use with an associated cotton harvester for conveying cotton, wherein the method includes conveying cotton harvested by a cotton picking unit of the associated cotton harvester to a crop storage receptacle of the associated cotton harvester using exclusively a forced airflow generated by an airflow generator of the associated cotton harvester.

In an implementation a method is provided for use with an associated cotton harvester for conveying cotton, wherein the method includes conveying cotton harvested by a cotton picking unit of the associated cotton harvester to a crop storage receptacle of the associated cotton harvester using exclusively a forced airflow generated by an airflow generator of the associated cotton harvester without any suction and/or suction forming or providing devices or systems disposed in or on an air duct coupling the cotton picking unit with the crop storage receptacle.

In an implementation a method is provided for use with an associated cotton harvester for conveying cotton, wherein the method includes conveying cotton harvested by a cotton picking unit of the associated cotton harvester to a crop storage receptacle of the associated cotton harvester using exclusively forced airflows generated by an airflow generator of the associated cotton harvester without any suction and/or suction forming or providing devices or systems disposed in or on an air duct coupling the cotton picking unit with the crop storage receptacle, wherein the forced airflows include an airflow originating within the cotton harvesting unit pushing cotton away from the cotton harvesting unit and into a duct system to help propel the cotton within the duct system towards the cotton storage receptacle using pressure within the duct system.

In an implementation a method is provided for use with an associated cotton harvester for conveying cotton, wherein the method includes conveying cotton harvested by a cotton picking unit of the associated cotton harvester to a crop storage receptacle of the associated cotton harvester using exclusively forced airflows generated by an airflow generator of the associated cotton harvester without any suction and/or suction forming or providing devices or systems disposed in or on an air duct coupling the cotton picking unit with the crop storage receptacle, wherein the forced airflows include an airflow originating within the cotton harvesting unit pushing cotton away from the cotton harvesting unit and into a duct system and a supplemental boost airflow generated by one or more cotton flow accelerators configured to receive air from an air source and having one or more boost nozzle end outlets opening in the duct system pushing the cotton within the duct system to help propel the cotton within the duct system towards the cotton storage receptacle using pressure within the duct system.

In the implementations herein, cotton flow accelerators in the form of nozzle ends disposed within the cotton picker row units generate the forced airflow induced in the cotton air duct system located between the picker units and the cotton storage receptacle of the harvester vehicle for conveying the cotton harvested at the picker units from the picker units to the accumulator or basket of the harvester via the air duct system.

In the implementations herein, the cotton flow accelerators in the form of nozzle ends disposed within the cotton picker row units exclusively generate all of the airflow induced in the cotton air duct system located between the picker row units and the cotton storage receptacle of the harvester vehicle for conveying the cotton harvested at the picker row units from the picker row units to the accumulator or basket of the harvester via the air duct system.

In the implementations herein, the cotton flow accelerators in the form of nozzle ends disposed within the cotton picker row units generate the airflow induced in the cotton air duct system located between the picker row units and the cotton storage receptacle of the harvester vehicle without the addition or assistance from any suction airflows or the like for conveying the cotton harvested at the picker row units from the picker row units to the cotton storage receptacle of the harvester vehicle via the air duct system.

In the implementations herein, the cotton flow accelerators in the form of nozzle ends disposed within the cotton picker row units exclusively generate all of the airflow induced in the cotton air duct system located between the picker row units and the cotton storage receptacle of the harvester vehicle without the addition or assistance from any suction airflows or the like for conveying the cotton harvested at the picker row units from the picker row units to the cotton storage receptacle of the harvester vehicle via the air duct system.

In accordance with an implementation, a cotton conveying system is provided for use with a cotton harvester including a crop storage receptacle. A cotton conveying system in accordance with an implementation includes a first cotton picking unit operable to harvest cotton, a first air duct coupled between the first cotton picking unit and the crop storage receptacle of the cotton harvester, an airflow generator operable to generate an airflow, and first and second nozzles. In accordance with an implementation, the first air duct provides an airtight seal between the first cotton picking unit and the crop storage receptacle of the cotton harvester. In accordance with an implementation, the first nozzle is coupled between the airflow generator and the first cotton picking unit to form a first airflow path generating a first harvesting airflow within the first cotton picking unit and a first forced airflow within the first air duct coupled with the first cotton picking unit. In accordance with an implementation, the second nozzle is coupled between the airflow generator and the first cotton picking unit to form a second airflow path generating a second harvesting airflow within the first cotton picking unit and a second forced airflow within the first air duct coupled with the first cotton picking unit. In accordance with an implementation, the first and second forced airflows combine within the first air duct to convey cotton harvested by the first cotton picking unit to the crop storage receptacle of the cotton harvester.

In accordance with a further implementation, a boosted forced airflow cotton conveying system is provided for a cotton harvester including a crop storage receptacle, wherein the boosted cotton conveying system includes a first cotton picking unit operable to harvest cotton, a first air duct coupled between the first cotton picking unit and the crop storage receptacle of the cotton harvester, an airflow generator operable to generate an airflow, a first cotton flow accelerator, and first and second nozzles coupled between the airflow generator and the first cotton picking unit. The first cotton flow accelerator is operably coupled with the first air duct and is configured to receive air from the airflow generator via a first hose and comprises one or more boost nozzle end outlets opening in the first air duct to direct a supplemental boost airflow pushing the cotton within the duct system to help propel cotton harvested by the first cotton picking unit within the first air duct towards the crop storage receptacle using pressure of the supplemental boost airflow within the first air duct. The first nozzle is coupled between the airflow generator and the first cotton picking unit via a further hose to form a first airflow path generating a first harvesting airflow within the first cotton picking unit and a first forced airflow within the first air duct coupled with the first cotton picking unit. The second nozzle is coupled between the airflow generator and the first cotton picking unit via the further hose to form a second airflow path generating a second harvesting airflow within the first cotton picking unit and a second forced airflow within the first air duct coupled with the first cotton picking unit. In the boosted forced airflow cotton conveying system, the first and second forced airflows combine together with the supplemental boost airflow within the first air duct to convey the cotton harvested by the first cotton picking unit to the crop storage receptacle of the cotton harvester, wherein the first air duct is under positive pressure for its full extent from the first cotton picking unit to the crop storage receptacle of the cotton harvester.

In any of the implementations, the first air duct is under positive pressure for its full extent from the first cotton picking row unit to the crop storage receptacle of the cotton harvester.

In any of the implementations, the cotton conveying system further includes first and second cotton conveying chutes.

In any of the implementations, the first cotton conveying chute couples the first nozzle with the first air duct and the first cotton picking unit, the first cotton conveying chute being located adjacent a front cotton drum of the first cotton picking unit.

In any of the implementations, the second cotton conveying chute couples the second nozzle with the first air duct and the first cotton picking unit, the second cotton conveying chute being located adjacent a rear cotton drum of the first cotton picking unit.

In any of the implementations, the first cotton conveying chute is configured to direct the first forced airflow to the first air duct, and the second cotton conveying chute is configured to direct the second forced airflow to the first air duct.

In any of the implementations, the first nozzle is substantially “J” shaped, and the second nozzle is substantially “J” shaped.

In any of the implementations, the first nozzle comprises a first nozzle end disposed within a housing of the first cotton picking unit, and the second nozzle comprises a pair of nozzle ends disposed within a housing of the first cotton picking unit.

In any of the implementations, the first nozzle end is configured to direct airflow pushing harvested cotton away from a first cotton harvesting unit of the first cotton picking unit and into the first air duct for conveying the harvested cotton to the crop storage receptacle of the cotton harvester, and the pair of nozzle ends are configured to direct airflow pushing the harvested cotton away from a second cotton harvesting unit of the first cotton picking unit and into the first air duct for conveying the harvested cotton to the crop storage receptacle of the cotton harvester.

In any of the implementations, the pair of nozzle ends span a bottom end of the second cotton harvesting unit.

In any of the implementations, the cotton conveying system further includes a “Y” shaped elbow having an inlet opening, a first outlet opening, and a second outlet opening, the first outlet opening being coupled with the first nozzle and the second outlet opening being coupled with the second nozzle.

In any of the implementations, the cotton conveying system further includes a hose coupled between the airflow generator and the inlet opening of the “Y” shaped elbow, the hose being operable to port the airflow generated by the airflow generator to the inlet opening of the “Y” shaped elbow and in turn to the first and second nozzles.

In any of the implementations, the cotton conveying system further includes a transition portion attached with a housing of the cotton picking unit, wherein the transition portion is operable to convey the first and second harvesting airflows, exiting from the housing of the cotton picking unit to the air duct of the air duct system as the first and second forced airflows.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

The examples disclosed herein may take physical form in certain parts and arrangement of parts, and will be described in detail in this specification and illustrated in the accompanying drawings which form a part hereof and wherein:

FIG. 1 is a perspective view of a cotton harvester that uses the forced airflow cotton conveying system according implementations of the present disclosure.

FIG. 2 is a side view of the harvester of FIG. 1.

FIG. 3A is a front perspective side view of a portion of an example arrangement of a forced airflow cotton conveying system, according to some implementations of the present disclosure.

FIG. 3B is a rear perspective view of a portion of an example arrangement of a boosted forced airflow cotton conveying system, according to some implementations of the present disclosure.

FIG. 4 is a perspective enlarged view of a portion of the cotton conveying system of FIG. 3.

FIG. 5 is a perspective view in partial fathom illustrating the interaction of portions of the cotton conveying system of FIGS. 3 and 4 with positions of an example cotton picking unit.

FIG. 6 is a side elevational view illustrating portions of the cotton conveying system of FIGS. 3-5 with positions of an example cotton picking unit.

FIG. 7A is a perspective view taken from a front area of a cotton picking unit illustrated in partial fathom showing the interaction of portions of a cotton conveying system with positions of an example cotton picking unit in accordance with an implementation.

FIG. 7B is a perspective view taken from a front area of a cotton picking unit illustrated in partial fathom showing the interaction of portions of a cotton conveying system with positions of an example cotton picking unit in accordance with an implementation.

FIG. 8A is a perspective view taken from a rear area of the cotton picking unit of FIG. 7A illustrated in partial fathom showing the interaction of portions of a cotton conveying system with positions of an example cotton picking unit in accordance with an implementation.

FIG. 8B is a perspective view taken from a rear area of the cotton picking unit of FIG. 7B illustrated in partial fathom showing the interaction of portions of a cotton conveying system with positions of an example cotton picking unit in accordance with an implementation.

FIG. 9A is a perspective view taken from a front area of the cotton picking unit of FIGS. 7A and 8A illustrated in partial fathom showing the interaction of portions of a cotton conveying system with positions of an example cotton picking unit in accordance with an implementation.

FIG. 9B is a perspective view taken from a front area of the cotton picking unit of FIGS. 7B and 8B illustrated in partial fathom showing the interaction of portions of a cotton conveying system with positions of an example cotton picking unit in accordance with an implementation.

FIG. 10A is a top perspective view of a cotton picking unit taken along line 10A-10A of FIG. 9A in partial fathom showing the interaction of portions of a cotton conveying system with positions of an example cotton picking unit in accordance with an implementation.

FIG. 10B is a top perspective view of a cotton picking unit taken along line 10B-10B of FIG. 9B in partial fathom showing the interaction of portions of a cotton conveying system with positions of an example cotton picking unit in accordance with an implementation.

FIG. 11 is a perspective view of a portion of an air duct attached with a housing of a cotton picking unit in accordance with an implementation.

FIG. 12 is a perspective view of a portion of a further air duct attached with a housing of a cotton picking unit in accordance with an implementation.

FIG. 13 is a perspective view of a portion of a still further air duct attached with a housing of a cotton picking unit in accordance with an implementation.

FIG. 14 is a perspective view of a portion of an air duct attached with a housing of a cotton picking unit in accordance with an implementation showing a cotton flow accelerator configured to receive air from the air source and having a boost nozzle end outlet opening in the duct system to direct a supplemental boost airflow pushing the cotton within the duct system.

### DETAILED DESCRIPTION

The implementations of the present disclosure described below are not intended to be exhaustive or to limit the disclosure to the precise forms in the following detailed description. Rather, the implementations are chosen and described so that others skilled in the art may appreciate and understand the principles and practices of the present disclosure.

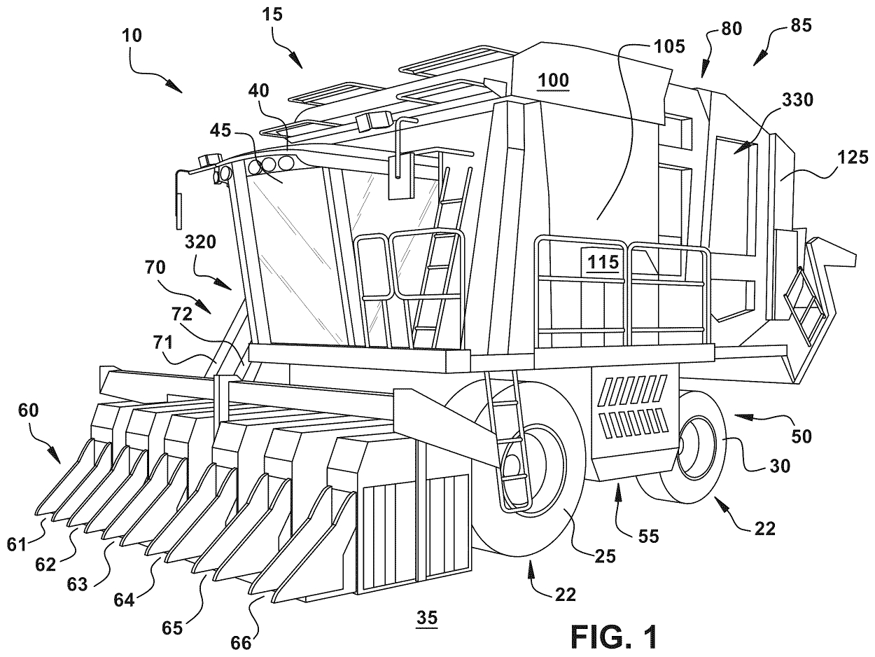

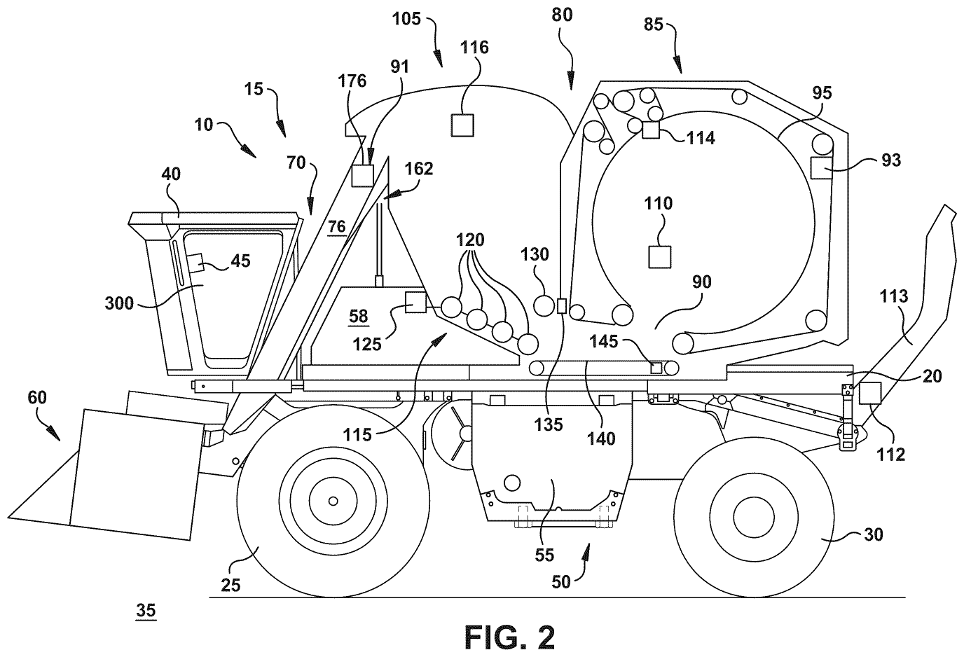

FIGS. 1 and 2 illustrate a harvester 10 suitable for harvesting cotton that uses the forced airflow cotton conveying system according implementations of the present disclosure. The illustrated harvester 10 is a cotton harvester 15 and, in particular, a cotton picker. The harvester 10 comprises a machine to harvest cotton crops. In one implementation such as for example the implementation shown, the harvester 10 is self-propelled. In another implementation, harvester 10 is towed. Harvester 10 removes portions of cotton plants (the cotton crop) from the growing medium or field. In one implementation, harvester 10 comprises a crop storage receptacle such as an accumulator or basket in which the cotton crop is held. In another implementation, harvester 10 routes the removed cotton crop into a temporary crop storage receptacle such as a temporary accumulator or basket of the harvester after forming the cotton crop into a desired shape such as into a cotton module or the like for subsequent handling, wherein the gathered or otherwise formed cotton crop may be subsequently discharged onto the ground for post-harvesting collection. In yet another implementation, harvester 10 discharges the removed cotton crop into a crop storage receptacle of another vehicle such as an accumulator or basket of the another vehicle whereat it may be formed, weighed, and then discharged onto the ground for subsequent collection. It is to be appreciated that types of harvesters other than the cotton harvester 15 of the example implementation are contemplated by this disclosure (e.g., cotton strippers, cotton pickers, cotton combines, etc.) as well.

The cotton harvester 15 of the example implementation includes a chassis 20. The illustrated chassis 20 is supported by ground engaging members 22 such as front wheels 25 and rear wheels 30 although other support is contemplated (e.g., tracks). The cotton harvester 15 is adapted for movement through a field 35 to harvest crops (e.g., cotton). An operator station 40 is supported by the chassis 20. An operator interface 45 is positioned in the operator station 40. A power module 50 may be supported below the chassis 20. The power module 50 may be an engine 55. Water, lubricant, and fuel tanks, indicated generally at 58 (FIG. 2), may be supported on the chassis 20.

A harvesting structure 60 is mutually coupleable with the chassis 20 as illustrated, and is configured to remove crops from the field 35. The harvesting structure 60 is a cotton harvesting structure such as shown for use in a cotton harvester 15, and may include one or more individual harvesting structures in the form of cotton picking row units 61-66 for example.

The harvesting structure 60 is mutually coupleable with an air duct system 70 at the lead end of the cotton harvester 15 in the illustrated implementation, wherein the air duct system 70 is configured to use forced air to urge and/or otherwise push crop processed by the harvesting structure 60 into the cotton harvester 15. In addition, a crop storage receptacle 80 is mutually coupleable with the air duct system 70 for receiving crop outputted from the air duct system 70. The air duct system 70 includes a plurality of separate air ducts 71-76, wherein only two (71 and 72) are labeled in the view of FIG. 1 and wherein only one (76) is shown in the view of FIG. 2, wherein each of the separate air ducts 71-76 is associated with one of the cotton picking row units 61-66 for communicating harvested cotton crop from the cotton picking row units 61-66 to the crop storage receptacle 80.

In the implementations herein the air duct system 70 is configured to use forced air exclusively to urge and/or otherwise push crop processed by the harvesting structure 60 into the cotton harvester 15.

In the implementations herein the air duct system 70 is configured to use forced air exclusively and without the addition or assistance from any suction airflows or the like, wherein the forced air flow exclusively urges and/or otherwise pushes crop processed by the harvesting structure 60 into the cotton harvester 15.

With reference to FIG. 2, the illustrated crop storage receptacle 80 includes a module builder 85 having a throat 90 and at least one baler belt 95. The module builder 85 forms the harvested cotton crop into round bales or “modules.” Referring to FIG. 1, a cleaner 100 is provided that cleans the cotton by removing trash and debris. The cleaner 100 is typically used in a cotton stripper harvester for cleaning the cotton harvested from a cotton stripper header by removing trash and debris. A pre-chamber such as for example an accumulator 105 is provided between the air duct system 70 and the module builder 85 of the crop storage receptacle 80. The accumulator 105 of the crop storage receptacle 80 is configured to receive cotton harvested by the cotton picking row units 61-66 as an intermediary step between handling by the air duct system 70 and the module builder 85 of the crop storage receptacle 80.

The cotton harvester 15 of the example implementation includes a harvesting sensor 91 disposed in general at or in the harvesting structure 60 and/or at or in the an air duct system 70, and an accumulated crop sensor 93 disposed in general at or in the module builder 85 of the crop storage receptacle 80. The harvesting sensor 91 is operative to generate a production signal representative of a production rate of the crop being harvested. The accumulated crop sensor 93 is operative to generate a bulk crop signal representative of a measured parameter of the crop harvested during selected time periods. In an example implementation, an apparatus (not shown) is provided for use with or in combination with a cotton harvester 15 for determining crop yield result information during harvesting of the crop, wherein the yield result information is useful for estimating, monitoring, reporting, and managing crop production, and it may also be used to assist with the control of selected functional systems of the harvester. Such apparatus may be calibrated in response to the signals generated by the harvesting and accumulated crop sensors 91, 93 for providing highly accurate crop harvest production results, wherein the calibration may be automatic, and further wherein the calibration may be automatic and continuous.

With reference to FIG. 2, a moisture feedback device 110 is disposed in the module builder 85 of the crop storage receptacle 80. In the example implementation, the moisture feedback device 110 is operative to generate or otherwise provide a moisture level signal that is indicative of the moisture content of the crop contained in the crop storage receptacle 80. The moisture feedback device 110 may be a moisture sensor device configured to generate an electrical signal having a magnitude indicative of the moisture content of the crop. The moisture feedback device 110 also may be a moisture sensor device capable of wired and/or wireless operative communication with a network of the cotton harvester such as for example a Controller Area Network (CAN), and configured to generate data that is recognized by other devices on the network as being representative of the moisture content of the crop. It is to be appreciated that although the moisture feedback device 110 of the example implementation is shown as being a single device disposed at the crop storage receptacle 80, the moisture feedback device 110 may be positioned anywhere on the cotton harvester 15 that it may be desirable to determine the moisture of the cotton crop as it is harvested and processed, and further that several moisture feedback devices may be provided at different locations on the cotton harvester 15 as deemed necessary or desirable to determine the moisture of the cotton crop as it is harvested and processed at the different locations on the cotton harvester 15.

In addition, a module mass feedback device 112 may be coupled with a module handler portion of the crop storage receptacle 80. In the example implementation, the module mass feedback device 112 may be any device that can generate a signal representative of the mass of each crop bundle after it is harvested such as for example a weight sensor, a torsional sensor, a spring gauge or any similar and/or equivalent device. In the example the module mass feedback device 112 is operative to generate or otherwise provide a bulk crop module mass signal indicative or otherwise representative of the mass of each cotton module after it is completed or otherwise built-up by the module builder 85. The module mass feedback device 112 may be a mass sensor device for example that is configured to generate an electrical signal having a magnitude indicative of the mass of the harvested cotton crop after it is bundled into a selected form such as for example a cotton module form. The module may be weighed as it is ejected via a module handler arm 113 from the module builder 85 of the cotton harvester 15. The module mass feedback device 112 also may be a mass sensor device capable of wired and/or wireless operative communication with a network of the cotton harvester such as for example a CAN, and configured to generate data that is recognized by other devices on the network as being representative of the mass of the bundled crop such as the mass of the cotton module. The module mass feedback device 112 may be operatively coupled with one or more mechanisms disposed between the crop storage receptacle 80 and the chassis 20 of the cotton harvester 15 for example, or anywhere else that may be suitable for measuring the mass of the bundled crop.

In further addition, a module diameter feedback device 114 may also be coupled with the cotton harvester 15 in the crop storage receptacle 80. In an example implementation, the module diameter feedback device 114 is coupled with a rockshaft (not shown) that is movable with the module builder 85 and in that way is operative to generate or otherwise provide a crop module diameter signal representative of a measured diameter of the crop harvested and processed into the desired bundle or other shape suitable for ease of handling such as for example a cotton module form. The module diameter feedback device 114 may be a sensor device capable of generating a signal having a magnitude indicative of the diameter of the crop after it is bundled into a selected form such as for example in the cotton module form. The module diameter feedback device 114 also may be a sensor device capable of wired and/or wireless operative communication with a network of the cotton harvester such as for example a CAN, and configured to generate data onto the network that is recognized by other devices on the network as being representative of the diameter of the bundled crop such as the diameter of the cotton module. The module diameter feedback device 114 may be operatively coupled with one or more mechanisms disposed between the crop storage receptacle 80 and the chassis 20 of the cotton harvester 15 for example, or anywhere else that may be suitable for measuring the diameter of the bundled crop.

In still further addition, an accumulator level feedback device 116 may also be coupled with the crop storage receptacle 80. In the example implementation, the accumulator level feedback device 116 is operative to generate or otherwise provide an accumulator level signal representative of a measured level of harvested crop fill of the accumulator 105 of the crop storage receptacle 80 of the cotton harvester 15. The accumulator level feedback device 116 may be a sensor device capable of generating a signal having a magnitude indicative of the fill level of the accumulator 105 of the crop storage receptacle 80. The accumulator level feedback device 116 also may be a sensor device capable of wired and/or wireless operative communication with a network of the cotton harvester such as for example a CAN, and configured to generate data onto the network that is recognized by other devices on the network as being representative of the level of harvested crops filling the accumulator 105 of the crop storage receptacle 80. The accumulator level feedback device 116 may be operatively coupled with one or more mechanisms disposed between the accumulator 105 of the crop storage receptacle 80 and the chassis 20 of the cotton harvester 15 for example, or anywhere else that may be suitable for measuring the level of harvested crops filling the accumulator 105 of the crop storage receptacle 80.

In further addition, a plurality of crop sensor devices 171-176 may be coupled with the plurality of air ducts 71-76, wherein only one crop sensor device (176) is shown in the view of FIG. 2, and wherein each of the crop sensor devices 171-176 is coupled with one of the air ducts 71-76 for providing a signal indicative of a parameter of the harvested crop as it flows through one of the air ducts 71-76. The crop sensor devices 171-176 may provide a signal indicative of a quantity of the harvested crop as it flows motivated by the forced airflow through one of the air ducts 71-76 for example. As described above, each of the separate air ducts 71-76 is associated with one of the cotton picking row units 61-66 for communicating the harvested cotton crop from the cotton picking row units 61-66 to the crop storage receptacle 80. In that way, each of the plurality of crop sensor devices 171-176 may generate a crop signal indicative of a parameter of the harvested crop as it flows through a respective one of the air ducts 71-76 to which the crop sensor device is coupled. In an example, each of the plurality of crop sensor devices 171-176 may generate a signal indicative of a quantity of the harvested crop as it flows through a respective one of the air ducts 71-76 to which the crop sensor device is coupled. In the implementation herein, the cotton crop harvested at the cotton picking row units 61-66 is communicated from the cotton picking row units 61-66 to the crop storage receptacle 80 using forced airflow exclusively, wherein each of the plurality of crop sensor devices 171-176 may generate a signal indicative of a quantity of the harvested crop as it flows motivated by the forced airflow through a respective one of the air ducts 71-76 to which the crop sensor device is coupled.

With continued reference to FIG. 2, a feeder 115 is mutually coupleable with the chassis 20. The feeder 115 is configured to receive the cotton crop from the accumulator 105 of the crop storage receptacle 80. The feeder 115 includes a plurality of meter rollers 120 configured to compress the cotton, and transfer the compressed cotton to the module builder 85 at a desired controlled feed rate. A first motor 125 is positioned to rotate the plurality of meter rollers 120. The first motor 125 may be hydraulic or electric.

At least one beater roller 130 is configured to cooperate with the plurality of meter rollers 120 to transfer the crop at a desired controlled feed rate. A second motor 135 is positioned to rotate the beater roller 130. The second motor 135 may be hydraulic or electric.

A feeder belt 140 is configured to receive crop from the plurality of meter rollers 120 and the at least one beater roller 130, and to transfer the cotton, or other crop to the throat 90 at a desired controlled feed rate. A third motor 145 is positioned to rotate the feeder belt 140. The third motor 145 may be hydraulic or electric.

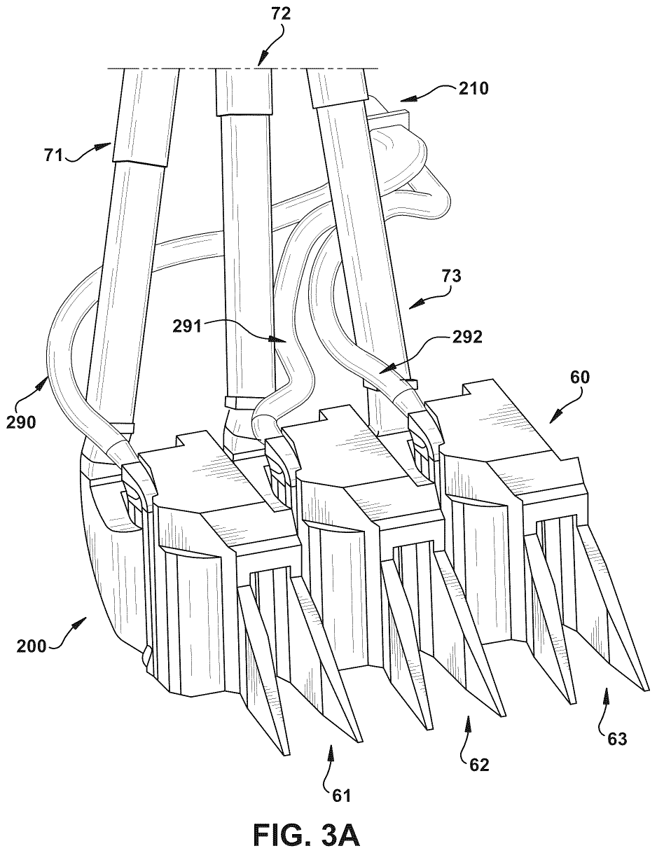

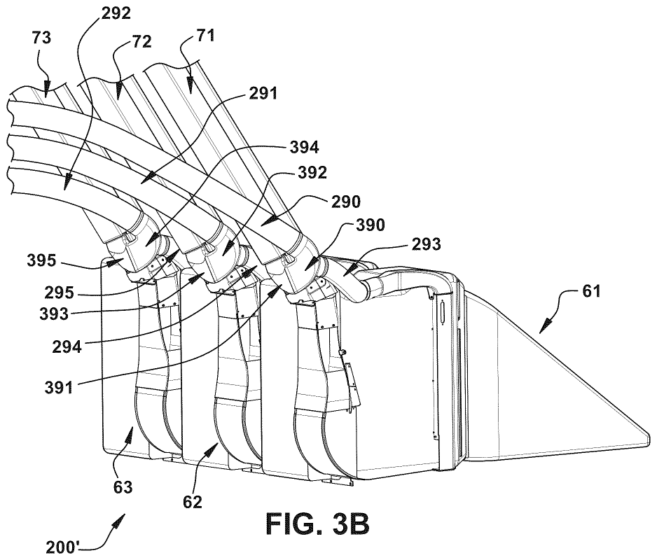

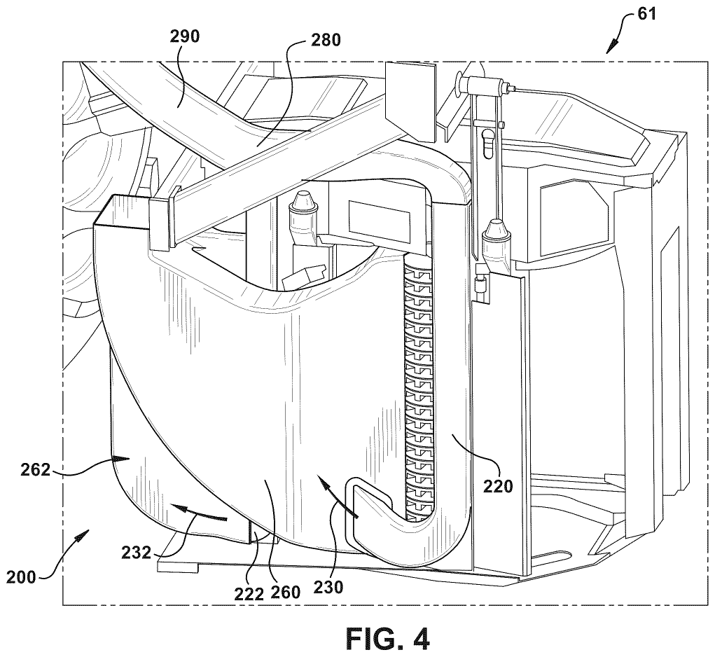

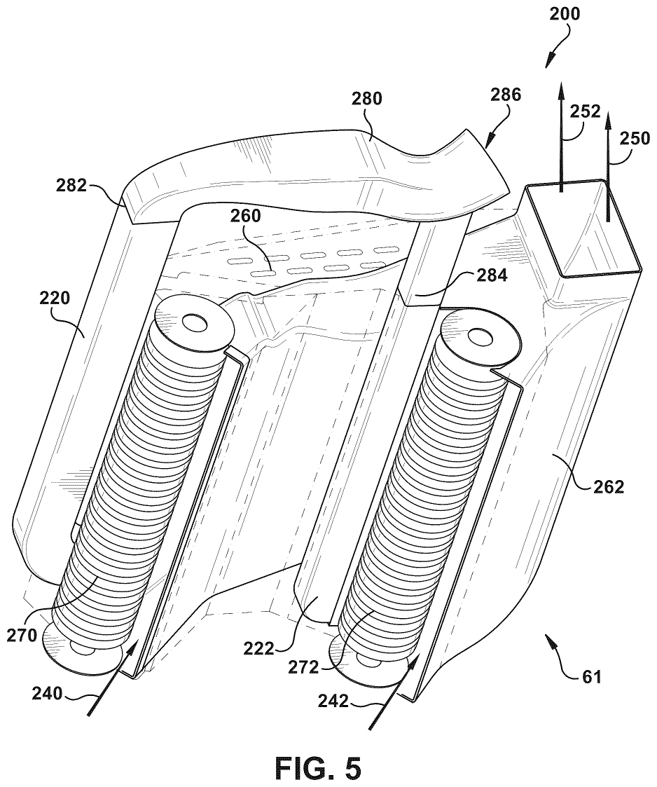

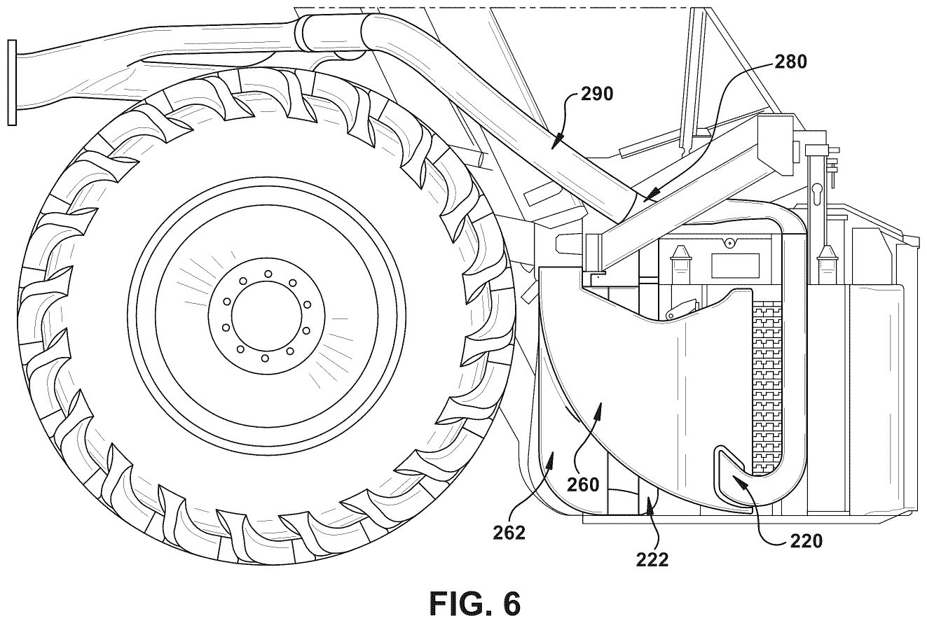

FIG. 3A is a front perspective side view of a portion of an example arrangement of a forced airflow cotton conveying system 200, according to some implementations of the present disclosure. FIG. 3B is a rear perspective side view of a portion of an example arrangement of a boosted forced airflow cotton conveying system 200', according to some implementations of the present disclosure. FIG. 4 is a perspective enlarged view of an example implementation of a portion of a cotton conveying system such as shown generally in FIGS. 3A and 3B. FIG. 5 is a perspective view in partial fathom illustrating the interaction of portions of a cotton conveying systems such as shown generally in FIGS. 3A, 3B, and 4 with positions of an example cotton picking unit, and FIG. 6 is a side elevational view illustrating portions of a cotton conveying system such as shown generally in FIGS. 3A, 3B, 4, and 5 with positions of an example cotton picking unit.

With reference now to those Figures, in the example illustrated the forced airflow cotton conveying system 200 and the boosted forced airflow cotton conveying system 200′ are configured for use with three (3) of the cotton picking row units 61, 62, 62 and correspondingly with three (3) of the air ducts 71, 72, 73 of the cotton harvester 15 illustrated in FIGS. 1 and 2. It is to be appreciated, however, that the forced airflow cotton conveying systems 200, 200′ may be configured for use with any one (1) or more of the cotton picking row units 61-67 and correspondingly with any one (1) or more of the air ducts 71-76 of the cotton harvester 15 illustrated in FIGS. 1 and 2. For simplicity and ease of description, the subject forced airflow cotton conveying systems 200, 200′ are shown in use with the three (3) right cotton picking row units 61, 62, 62 and correspondingly with the three (3) right air ducts 71, 72, 73 of the cotton harvester 15 illustrated in FIGS. 1 and 2. It is to be appreciated that a similar cotton conveying systems (not shown) are provided in accordance with the example implementations herein for use with the three (3) left cotton picking row units 63, 64, 65 and correspondingly with the three (3) left air ducts 74, 75, 76 of the cotton harvester 15 illustrated in FIGS. 1 and 2. In the example implementation, the right and left forced airflow cotton conveying systems 200 are identically formed and are essentially mirror images of each other for use with the harvesting structure 60 of the cotton harvester 15. Similarly in the example implementation, the right and left boosted forced airflow cotton conveying systems 200′ are identically formed and are essentially mirror images of each other for use with the harvesting structure 60 of the cotton harvester 15.

The forced airflow cotton conveying system 200 of FIG. 3A is coupled to the harvesting structure 60. The forced airflow cotton conveying system 200 and the harvesting structure 60 may be similar to the air duct arrangement 70 and cotton harvesting row units 61-66, respectively, described in the context of the cotton harvester 15 of FIGS. 2 and 3. As shown in FIGS. 4 and 5, airflows 230, 232, 240, 242, 250, and 252 represented as arrows indicate the general directions of air flow within the cotton conveying system 200 and cotton picking unit 61.

Similarly, the boosted forced airflow cotton conveying system 200′ of FIG. 3B is coupled to the harvesting structure 60. The boosted forced airflow cotton conveying system 200′ and the harvesting structure 60 may be similar to the air duct arrangement 70 and cotton harvesting row units 61-66, respectively, described in the context of the cotton harvester 15 of FIGS. 2 and 3. As shown in FIGS. 4 and 5, airflows 230, 232, 240, 242, 250, and 252 represented as arrows indicate the general directions of air flow within the boosted cotton conveying system 200′ and cotton picking unit 61.

As shown in FIGS. 3A and 3B, forced airflow cotton conveying systems 200, 200′ are provided for use with an associated cotton harvester 15 that includes a crop storage receptacle 80 that may include an accumulator 105 and a module builder 85 to be described below in greater detail. In accordance with an example implementation, the forced airflow cotton conveying systems 200, 200′ include a first cotton picking unit 61 operable to harvest cotton, and a first air duct 71 coupled between the first cotton picking unit 61 and the crop storage receptacle 80 of the cotton harvester 15. The forced airflow cotton conveying systems 200, 200′ in accordance with example implementations each further include an airflow generator 210 (not shown in FIG. 3B) operable to generate an airflow. As shown in FIG. 3A with regard to the forced airflow cotton conveying system 200 example implementation, a hose 290 of the forced airflow cotton conveying system 200 is directly coupled between the airflow generator 210 and an inlet opening to be described in greater detail below at the first cotton picking unit 61, wherein the hose 290 is operable to port an airflow generated by the airflow generator 210 to the inlet opening at the first cotton picking unit 61. Similarly, as shown, further hoses 291, 292 are directly coupled between the airflow generator 210 and inlet openings at the second and third cotton picking units 62, 63, wherein the hoses 291, 292 are each operable to port an airflow generated by the airflow generator 210 to the inlet openings at the second and third cotton picking units 62, 63.

It is to be appreciated that the first air duct 71 in connection with the forced airflow cotton conveying system 200 of FIG. 3A provides an airtight seal between the first cotton picking unit 61 and the crop storage receptacle 80 of the cotton harvester 15. In this way, all of airflow received by the first air duct 71 from the first cotton picking unit 61 is communicated to the crop storage receptacle 80 without loss or interference. Similarly, the air ducts 72, 73 in connection with the forced airflow cotton conveying system 200 of FIG. 3A each provide an airtight seal between each of the cotton picking units 62, 63 and the crop storage receptacle 80 of the cotton harvester 15. In this way, all of the airflow received by each of the air ducts 72, 73 from each of the cotton picking units 62, 63 is communicated to the crop storage receptacle 80 without loss or interference.

As shown in FIG. 3B with regard to the boosted forced airflow cotton conveying system 200′ example implementation, a first cotton flow accelerator 390 connects the airflow generator 210 (not shown in FIG. 3B) with the first air duct 71 thereby bypassing the first cotton picking unit 61 with a portion of the airflow generated by the airflow generator 210. In an implementation, the first cotton flow accelerator 390 directs about 10% to 30% of the airflow generated by the airflow generator 210 and received via hose 290 to the first air duct 71, and the remainder of about 90% to 70% to the first cotton picking unit 61 via a further hose 393. In an implementation, the first cotton flow accelerator 390 directs 20% of the airflow generated by the airflow generator 210 and received via hose 290 to the first air duct 71, and 80% to the first cotton picking unit 61 via the further hose 393.

In any of the implementations, the first cotton flow accelerator 390 directs a range of about 0% to 40% of the airflow generated by the airflow generator 210 and received via hose 290 to the first air duct 71, and the remainder in the corresponding range of about 100% to 60% to the first cotton picking unit 61 via a further hose 393. In an implementation, the first cotton flow accelerator 390 directs 26% of the airflow generated by the airflow generator 210 and received via hose 290 to the first air duct 71, and 74% to the first cotton picking unit 61 via the further hose 393.

As shown, the hose 290 of the boosted forced airflow cotton conveying system 200′ couples the airflow generator 210 with the first cotton flow accelerator 390, and the further hose 293 couples the first cotton flow accelerator 390 with the inlet opening at the first cotton picking unit 61 to be described in greater detail below. The first cotton flow accelerator 390 is configured to receive air from the airflow generator 210 and has one or more boost nozzle end outlets 391 opening in the first air duct 71 to direct a supplemental boost airflow pushing the cotton within the first air duct 71 to help propel the cotton within the first air duct 71 towards the crop storage receptacle 80.

Similarly, the hoses 291, 292 of the boosted forced airflow cotton conveying system 200′ couple the airflow generator 210 with second and third cotton flow accelerators 392, 394, respectively, and further hoses 294, 295 couple the second and third cotton flow accelerators 392, 394 with inlet openings at the second and third cotton picking units 62, 63, respectively. The second and third cotton flow accelerators 392, 394 are configured to receive air from the airflow generator 210 and have one or more boost nozzle end outlets 393, 395 opening in the second and third air ducts 72, 73 to direct supplemental boost airflows pushing the cotton within the second and third air ducts 72, 73 to help propel the cotton within the second and third air ducts 72, 73 towards the crop storage receptacle 80.

The one or more forced airflows of the implementations herein including the one or more supplemental boost airflows are, essentially, one or more streams of air that maintain at all regions of the picker row units and/or ducts of the cotton harvester downstream of the one or more streams of air, a pressure of one (1) atmosphere (atm) or above 1 atm.

It is to be further appreciated that the first air duct 71 in connection with the boosted forced airflow cotton conveying system 200′ of FIG. 3B essentially provides an interrupted sealed conduit between the first cotton picking unit 61 and the crop storage receptacle 80 of the cotton harvester 15 in the sense that a first cotton flow accelerator 390 is provided for porting a supplemental boost airflow under a positive pressure from the airflow generator 210 via the first hose 290 into the first air duct 71 wherein the first portion of the airflow received from the airflow generator 210 is routed to the first air duct 71 via the first cotton flow accelerator 390 under a positive pressure of at least 1 atm. In this way, all of airflow received by the first air duct 71 from the first cotton picking unit 61 under positive pressure and from the first cotton flow accelerator 390 also under positive pressure is communicated to the crop storage receptacle 80 without loss or interference, and without creating any vacuums and/or vacuum region(s) in the duct 71 or elsewhere.

In accordance with the implementations herein the cotton conveying systems 200, 200′ do not rely on or use a suction force in or on any part of the air ducts 71-76, but rather rely upon one or more forced airflows that exist the row units 61-67 and/or that exit the cotton flow accelerators 390-394, for entraining the harvested cotton under positive pressure the entire length of the air ducts 71-76 and carrying the cotton along the length of the air ducts 71-76 to the crop storage receptacle 80 of the cotton harvester 15. In this way any inefficiencies that might occur associated with using a suction airflow as the primary or main airflow within the air ducts 71-76 are eliminated. Further in this way any of the inefficiencies of using a combination of a suction airflow as the main or primary airflow within the air ducts 71-76 and a pressurized airflow within the picker units for purposes of agitating the cotton for helping to discourage accumulation within the picker units are also eliminated.

With continued reference to FIGS. 3A, 3B, and 4-6, the forced airflow cotton conveying systems 200, 200′ in accordance with example implementations, further include first and second nozzles 220, 222 disposed in one or more of the cotton picking units 61-66. As illustrated, the first nozzle 220 is coupled between the airflow generator 210 and the first cotton picking unit 61 to form a first harvesting airflow path 230 generating a first harvesting airflow 240 within the first cotton picking unit 61 and a first forced airflow 250 within the first air duct 71 coupled with the first cotton picking unit 61.

Similarly and as illustrated, the second nozzle 222 is coupled between the airflow generator 210 and the first cotton picking unit 61 to form a second harvesting airflow path 232 generating a harvesting airflow 242 within the first cotton picking unit 61 and a second forced airflow 252 within the first air duct 71 coupled with the first cotton picking unit 61.

It is to be appreciated that in accordance with the example implementations the first and second harvesting airflows 240, 242 occur within the first cotton picking unit 61, and that the first and second forced airflows 250,252 occur within the first air duct 71.

It is to be appreciated that in accordance with the example implementations the first harvesting airflow 240 is located immediately adjacent to a front cotton drum 270 of the first cotton picking unit 61, and that the second harvesting airflow 242 is located immediately adjacent to a rear cotton drum 270 of the first cotton picking unit 61.

In accordance with an implementation, the first and second harvesting airflows 240, 242 occur and are contained completely within the first cotton picking unit 61, and that the first and second forced airflows 250, 252 occur and are contained completely within the first air duct 71.

In accordance with the example implementation illustrated the first and second forced airflows 250, 252 combine within the first air duct 71 to convey cotton harvested by the first cotton picking unit 61 to the crop storage receptacle 80 of the cotton harvester 15. In accordance with the example implementation illustrated the first and second forced airflows 250, 252 combine within the first air duct 71 to convey the cotton under pressure and using forced air to the crop storage receptacle 80 of the cotton harvester 15. Overall, first and second forced airflows 250, 252 may be generated at each of the cotton picking row units 61-63 and combined within the respective air ducts 71-73 to convey the cotton under pressure and using forced air to the crop storage receptacle 80 of the cotton harvester 15.

In accordance with the example implementation of the boosted forced airflow cotton conveying system 200′ illustrated, the first and second forced airflows 250, 252 combine within the first air duct 71 together with the supplemental boost airflow generated by the first cotton flow accelerator 390, to convey the cotton under pressure and using forced air to the crop storage receptacle 80 of the cotton harvester 15. Overall, first and second forced airflows 250, 252 may be generated at each of the cotton picking row units 61-63 and combined within the respective air ducts 71-73 together with the supplemental boost airflows generated by the respective cotton flow accelerators 390-394 to convey the cotton under pressure and using forced air to the crop storage receptacle 80 of the cotton harvester 15.

In accordance with the example implementations of the subject forced airflow cotton conveying systems 200, 200′ illustrated, the first air duct 71 of the subject cotton conveying system 200 is under positive pressure for its full extent from the first cotton picking unit 61 to the crop storage receptacle 80 of the cotton harvester 15. Further in accordance with the example implementations illustrated, each of the air ducts 71-76 of the subject cotton conveying system 200 is under positive pressure for its full extent from the respective cotton picking unit 61-66 to the crop storage receptacle 80 of the cotton harvester 15.

In accordance with the example implementation illustrated the forced airflow cotton conveying systems 200, 200′ further include a first cotton conveying chute 260 coupling the first nozzle 220 with the first air duct 71 and the first cotton picking unit 61. As illustrated, the first cotton conveying chute 260 is located adjacent the front cotton drum 270 of the first cotton picking unit 61. In this way, the first harvesting airflow 240 generated within the first cotton picking unit 61 by the airflow exiting the first nozzle 220 effectively and efficiently draws cotton from off of the front cotton drum 270. In accordance with the example implementation illustrated the first cotton conveying chute 260 is located adjacent the front cotton drum 270 and within a housing of the first cotton picking unit 61.

Further in accordance with the example implementation illustrated the cotton conveying system 200 further includes a second cotton conveying chute 262 coupling the second nozzle 222 with the first air duct 71 and the first cotton picking unit 61. As illustrated, the second cotton conveying chute 262 is located adjacent the rear cotton drum 272 of the first cotton picking unit 61. As illustrated, the second cotton conveying chute 262 is located adjacent the rear cotton drum 272 of the first cotton picking unit 61. In this way, the second suction airflow 242 generated within the first cotton picking unit 61 by the airflow exiting the second nozzle 222 effectively and efficiently draws cotton from the rear cotton drum 272. In accordance with the example implementation illustrated the second cotton conveying chute 262 is located adjacent a rear cotton drum 272 and within the housing of the first cotton picking unit 61.

It is to be appreciated that the first cotton conveying chute 260 of the subject cotton conveying systems 200, 200′ according to the implementations illustrated is configured to form and direct the first forced airflow 250 to the first air duct 71. It is further to be appreciated that the second cotton conveying chute 262 of the subject cotton conveying systems 200, 200′ according to the implementations illustrated is configured to form and direct the second forced airflow 252 to the first air duct 71.

It is to be appreciated and as will be described and shown below that the first and second cotton conveying chutes 260, 262 of the subject cotton conveying systems 200, 200′ according to the implementations illustrated may be configured by various internal and/or external baffles or the like disposed on and/or within the housings of the cotton picking unit 61-66 to form and direct the forced airflows 250, 252 to the respective air ducts 71-76.

FIG. 4 best illustrates that the first and second nozzles 220, 222 are substantially “J” shaped and, as will be shown and described in greater detail below, include one or more nozzle ends disposed within housings of the cotton picking unit 61-66 and configured to direct airflow pushing cotton away from a cotton harvesting unit and into a duct system for conveying the harvested cotton to an accumulator or basket of the harvester vehicle. In this way, the first and second airflow paths 230, 232 may be directed generally from the front of the first cotton picking unit 61 and generally along the bottom floor of the first cotton picking unit 61 for helping to direct and motivate the harvested cotton generally towards the rear of the first cotton picking unit 61 for gathering in a consolidated fashion within the duct 71 and entrained in the first and second forced airflows 250, 252 for eventual conveyance to the crop storage receptacle 80 of the cotton harvester 15.

As best shown in FIGS. 4, 5, and 6 the forced airflow cotton conveying systems 200, 200′ according to the illustrated implementations further include a “Y” shaped elbow 280 and the hose 290. In general, the “Y” shaped elbow 280 has an inlet opening 286, a first outlet opening 282, and a second outlet opening 284. As shown, the first outlet opening 282 is coupled with the first nozzle 220, and the second outlet opening 284 is coupled with the second nozzle 222.

As best shown in FIGS. 3 and 4, the hose 290 of the example implementation is coupled between the airflow generator 210 and the inlet opening 286 of the “Y” shaped elbow 270. In the example implementation, the hose 290 is operable to port the airflow generated by the airflow generator 210 (FIG. 1) to the inlet opening 286 of the “Y” shaped elbow 270 and in turn to the first and second nozzles 220, 222.

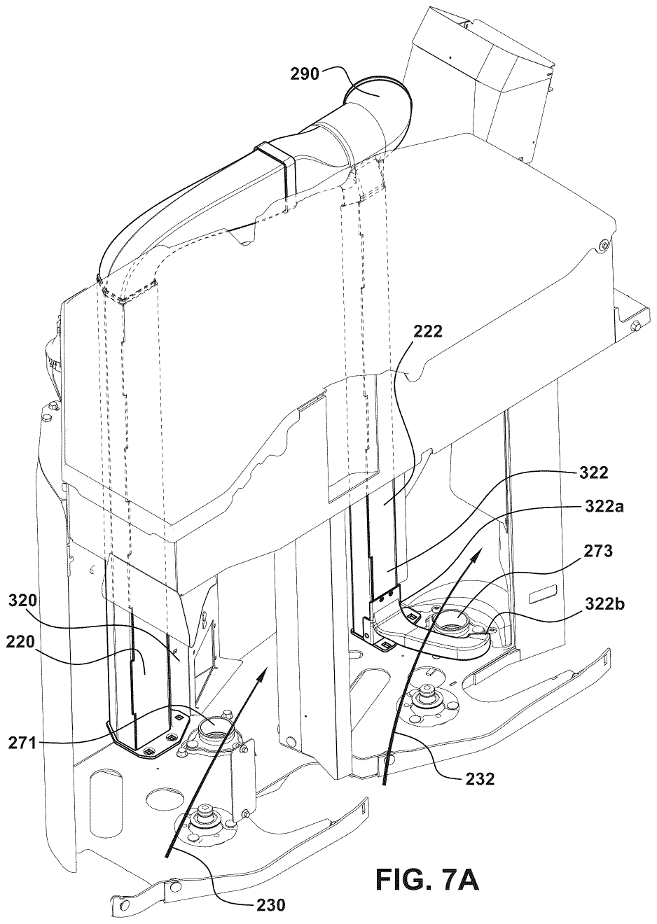

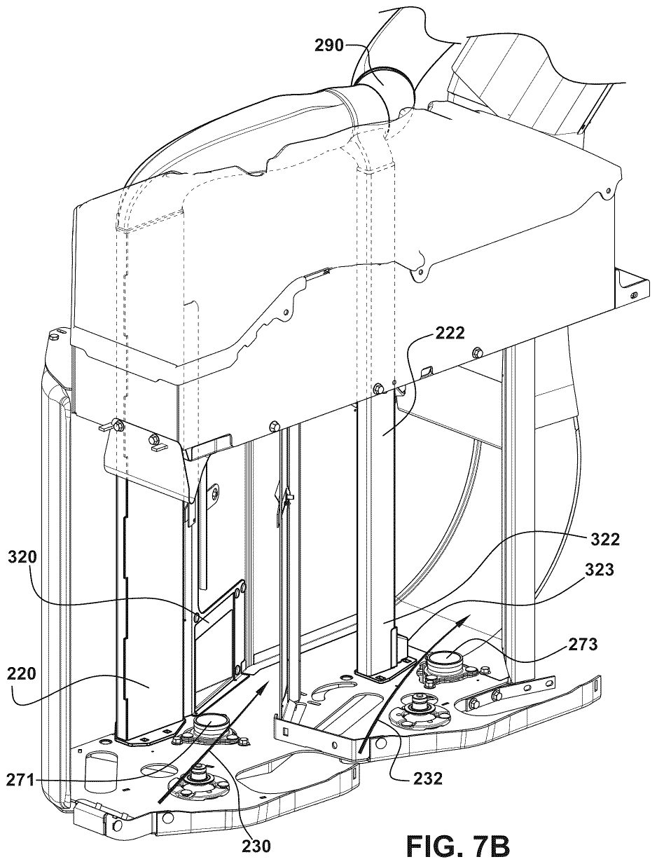

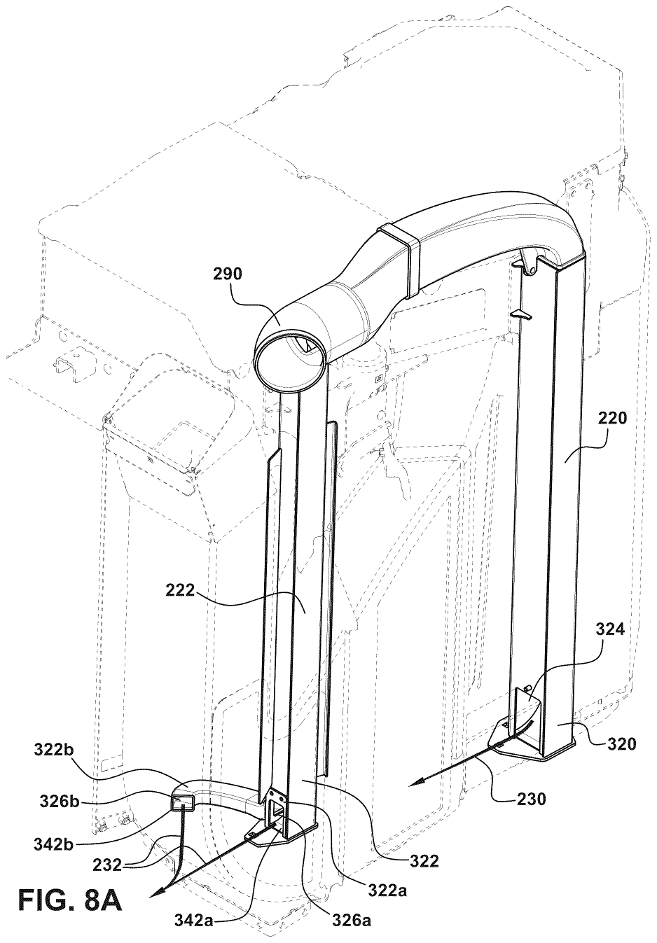

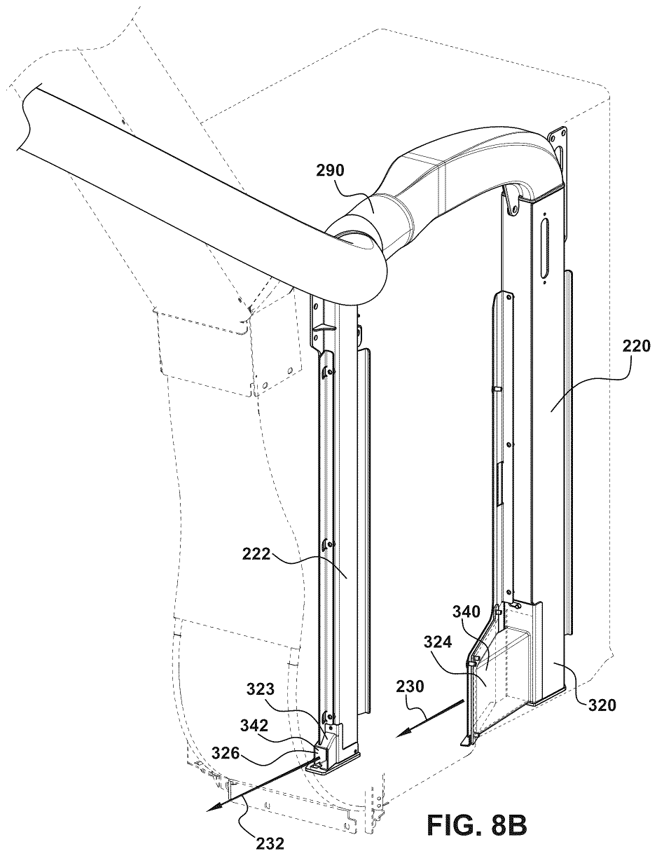

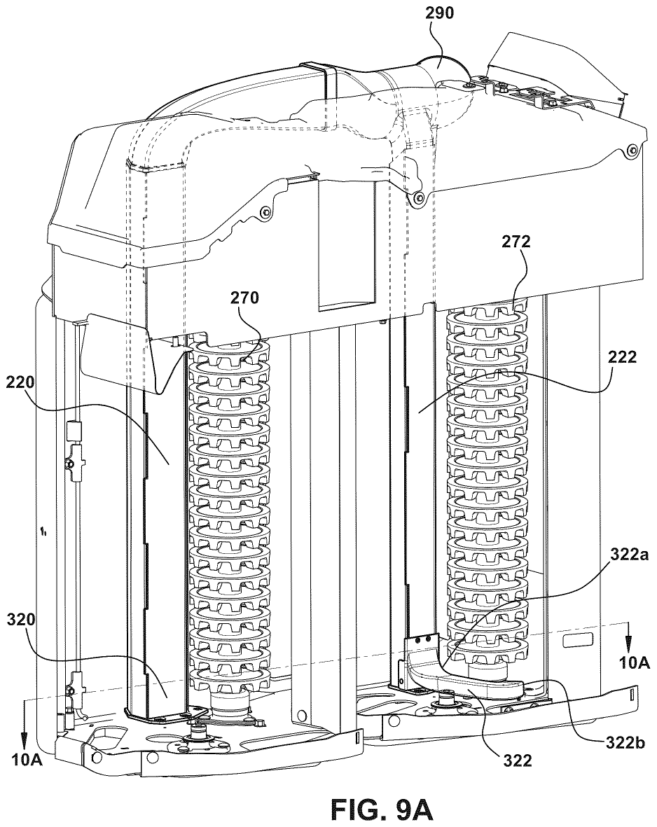

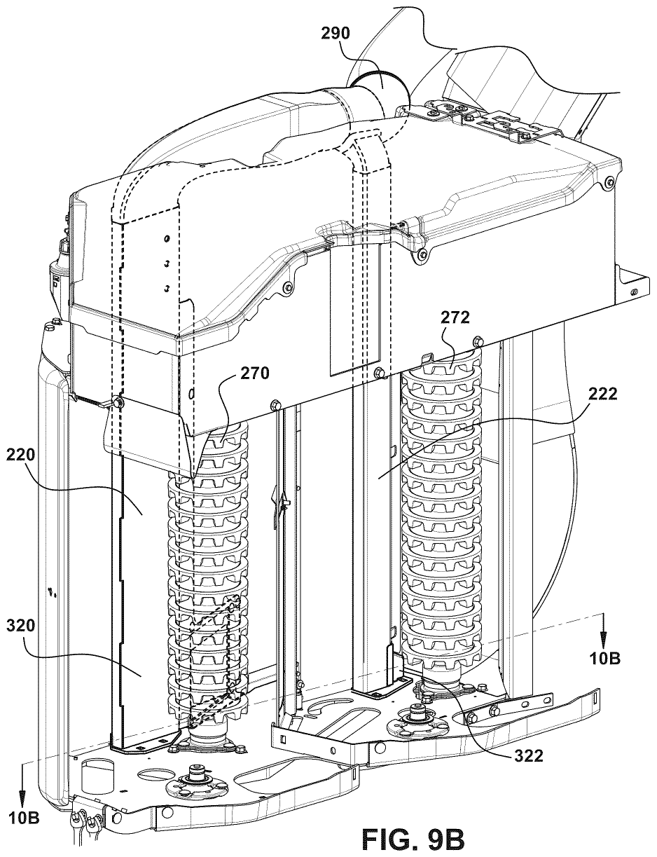

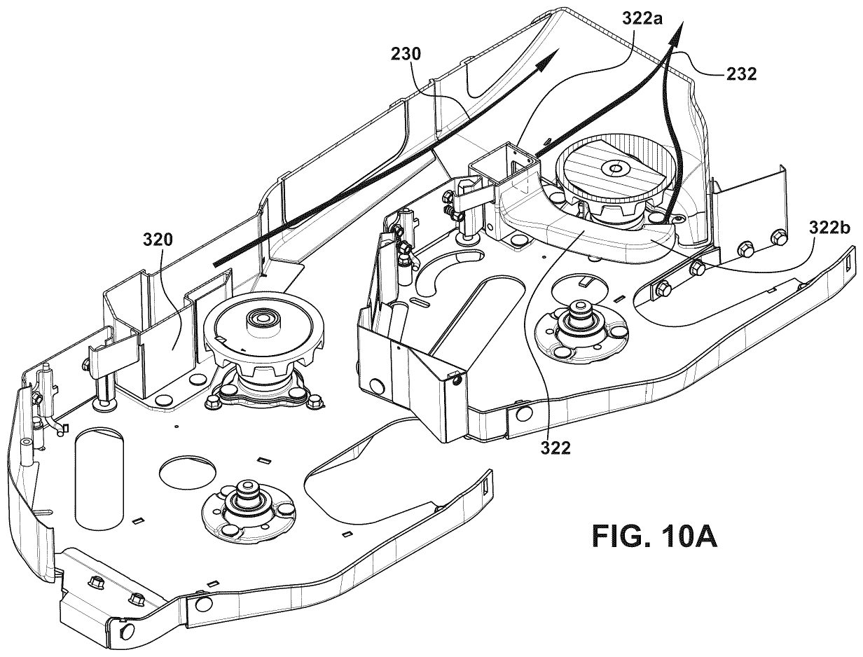

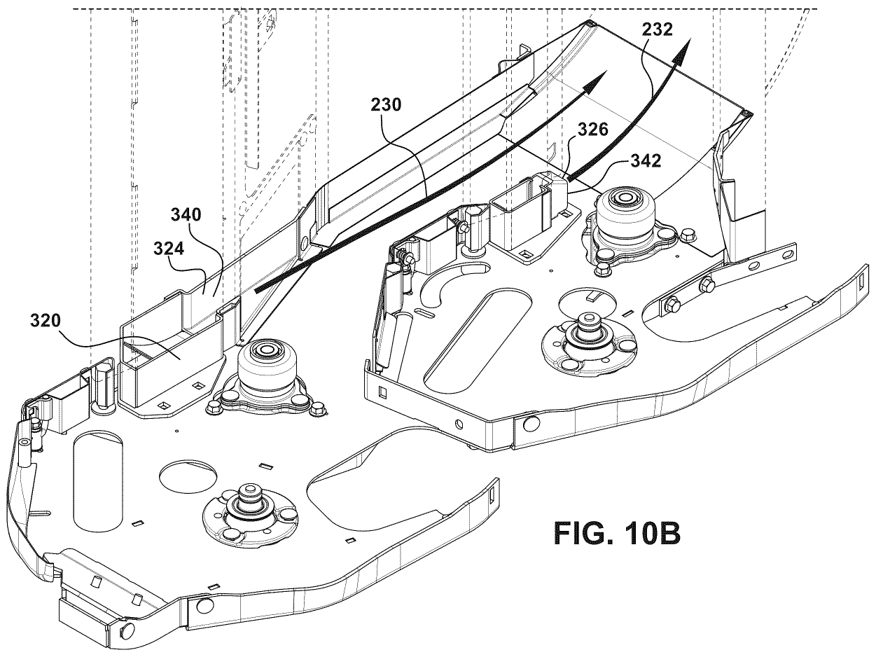

As mentioned above and with reference next to FIGS. 7A, 8A, 9A, and 10A the first and second nozzles 220, 222 in accordance with an example implementation include one or more nozzle ends 320, 322 disposed within the housings of the cotton picking units 61-66. The one or more nozzle ends 320, 322 are configured to form and direct airflows pushing cotton away from a cotton harvesting unit such as for example from the first and second cotton drums 270, 272 (shown in FIG. 9A and removed for ease of reference in FIGS. 7A and 8A) and into a respective duct system for conveying the harvested cotton to an accumulator or basket of the harvester vehicle. In this way, the first and second airflow paths 230, 232 may be directed generally from the front of each the cotton picking units 61-66 and generally along the bottom floor of the cotton picking units 61-66 for helping to direct and motivate the harvested cotton generally towards the rear of the cotton picking units 61-66 for gathering in a consolidated fashion within the respective ducts 71-76 and entrained in the first and second forced airflows 250, 252 in each of the ducts 71-76 of the cotton picking units 61-66 for eventual conveyance to the crop storage receptacle 80 of the cotton harvester 15. The one or more nozzle ends 320, 322 may control one or more of the rate of flow, speed, direction, mass, shape, and/or the pressure of the stream of pressurized air that emerges from them.

FIGS. 7A, 8A, and 9A show a representative cotton picking unit 61 with the first and second cotton drums 270, 272 removed, and FIG. 9A shows the representative cotton picking unit 61 with the first and second cotton drums 270, 272 in place. In FIGS. 7A and 8A, the bottom of the first cotton drum 270 would occupy area 271 within the housing of the representative cotton picking unit 61 and, similarly, the bottom of the second cotton drum 272 would occupy area 273 within the housing of the representative cotton picking unit 61.

In the implementation shown, the first nozzle 220 includes a nozzle end 320 disposed within the housing of the representative cotton picking unit 61. The nozzle end 320 is configured to direct airflow pushing cotton away from a cotton harvesting unit such as for example from the first cotton drum 270 (shown in FIG. 9A and removed for ease of reference in FIGS. 7A and 8A) and into a respective duct system for conveying the harvested cotton to an accumulator or basket of the harvester vehicle. Similarly in the implementation shown, the second nozzle 222 includes a pair of nozzle ends 322a, 322b disposed within the housing of the representative cotton picking unit 61. The pair of nozzle ends 322a, 322b are configured to direct airflow pushing cotton away from a cotton harvesting unit such as for example from the second cotton drum 272 (shown in FIG. 9A and removed for ease of reference in FIGS. 7A and 8A) and into a respective duct system for conveying the harvested cotton to an accumulator or basket of the harvester vehicle.

As shown best in FIG. 8A, the nozzle end 320 of the first nozzle 220 is formed by a nozzle opening 340 disposed within the representative cotton picking unit 61 and located at or on the floor thereof. Similarly, the nozzle ends 322a, 322b of the second nozzle 222 are formed by nozzle openings 342a, 342b disposed within the representative cotton picking unit 61 and located at or on the floor thereof. In this way, the first and second airflow paths 230, 232 created by the forced air exiting the openings 340 and 342a, 342b of the nozzle ends 320 and 322a, 322b, respectively, in each of the picking units 61-66 may be directed generally from the front of each of the cotton picking units 61-66 and generally along the bottom floors thereof for helping to direct and motivate the harvested cotton generally towards the rear of cotton picking units 61-66 for gathering in a consolidated fashion within the ducts 71-76 and entrained in the first and second forced airflows 250, 252 within the ducts 71-76 for eventual conveyance to the crop storage receptacle 80 of the cotton harvester 15.

As shown best in FIG. 8A, the nozzle end 320 of the first nozzle 220 formed by the nozzle opening 340 disposed within the representative cotton picking unit 61 and located at or on the floor thereof defines a nozzle outlet 324. The nozzle ends 322a, 322b of the second nozzle 222 formed by the nozzle openings 342a, 342b disposed within the representative cotton picking unit 61 and located at or on the floor thereof define nozzle outlets 326a, 326b, respectively.

In accordance with an example implementation, the nozzle outlet 324 defines an airflow outlet area that is larger than an airflow outlet area defined by the nozzle openings 342a, 342b collectively. In accordance with an example implementation, the airflow outlet area defined by the nozzle outlet 324 is in the range of five (5) to ten (10) times larger than the airflow outlet area defined by the nozzle openings 342a, 342b collectively. In accordance with a further example implementation, the airflow outlet area defined by the nozzle outlet 324 is about seven (7) times larger than the airflow outlet area defined by the nozzle openings 342a, 342b collectively.

In any of the implementations, the airflow outlet area defined by the nozzle outlet 324 together with the airflow outlet areas defined by the nozzle openings 342a, 342b define a combined nozzle airflow outlet area, and the cotton flow accelerator 391 defines a cotton flow accelerator outlet area.

In any of the implementations, the combined nozzle airflow outlet area comprises a range of 60%-100% of the overall combined area defined by the nozzle airflow outlet area together with the cotton flow accelerator outlet area, and the cotton flow accelerator outlet area comprises a corresponding range of 40%-0% of the overall combined area defined by the nozzle airflow outlet area together with the cotton flow accelerator outlet area.

In any of the implementations, the combined nozzle airflow outlet area comprises 74% of the overall combined area defined by the nozzle airflow outlet area together with the cotton flow accelerator outlet area, and the cotton flow accelerator outlet area comprises a corresponding 26% of the overall combined area defined by the combined nozzle airflow outlet area together with the cotton flow accelerator outlet area.

In any of the implementations, the airflow flowing out from the nozzle outlet 324 together with the airflow flowing from the nozzle openings 342a, 342b comprises a range of 60%-100% of the airflow within the first air duct flowing to the crop storage receptacle of the cotton harvester, and the supplemental boost airflow comprises a corresponding range of 40%-0% of the airflow within the first air duct flowing from the cotton flow accelerator 390 to the crop storage receptacle of the cotton harvester.

In any of the implementations, the airflow flowing out from the nozzle outlet 324 together with the airflow flowing from the nozzle openings 342a, 342b comprises 74% of the airflow within the first air duct flowing to the crop storage receptacle of the cotton harvester, and the supplemental boost airflow comprises a corresponding 26% of the airflow within the first air duct flowing from the cotton flow accelerator 390 to the crop storage receptacle of the cotton harvester.

As mentioned above and with reference next to FIGS. 7B, 8B, 9B, and 10B the first and second nozzles 220, 222 in accordance with an example implementation include one or more nozzle ends 320, 322 disposed within the housings of the cotton picking units 61-66. The one or more nozzle ends 320, 322 are configured to form and direct airflows pushing cotton away from a cotton harvesting unit such as for example from the first and second cotton drums 270, 272 (shown in FIG. 9B and removed for ease of reference in FIGS. 7B and 8B) and into a respective duct system for conveying the harvested cotton to an accumulator or basket of the harvester vehicle. In this way, the first and second airflow paths 230, 232 may be directed generally from the front of each the cotton picking units 61-66 and generally along the bottom floor of the cotton picking units 61-66 for helping to direct and motivate the harvested cotton generally towards the rear of the cotton picking units 61-66 for gathering in a consolidated fashion within the respective ducts 71-76 and entrained in the first and second forced airflows 250, 252 in each of the ducts 71-76 of the cotton picking units 61-66 for eventual conveyance to the crop storage receptacle 80 of the cotton harvester 15. The one or more nozzle ends 320, 322 may control one or more of the rate of flow, speed, direction, mass, shape, and/or the pressure of the stream of pressurized air that emerges from them.

FIGS. 7B, 8B, and 9B show a representative cotton picking unit 61 with the first and second cotton drums 270, 272 removed, and FIG. 9B shows the representative cotton picking unit 61 with the first and second cotton drums 270, 272 in place. In FIGS. 7B and 8B, the bottom of the first cotton drum 270 would occupy area 271 within the housing of the representative cotton picking unit 61 and, similarly, the bottom of the second cotton drum 272 would occupy area 273 within the housing of the representative cotton picking unit 61.

In the implementation shown, the first nozzle 220 includes a nozzle end 320 disposed within the housing of the representative cotton picking unit 61. The nozzle end 320 is configured to direct airflow pushing cotton away from a cotton harvesting unit such as for example from the first cotton drum 270 (shown in FIG. 9B and removed for ease of reference in FIGS. 7B and 8B) and into a respective duct system for conveying the harvested cotton to an accumulator or basket of the harvester vehicle. Similarly in the implementation shown, the second nozzle 222 includes a nozzle end 323 disposed within the housing of the representative cotton picking unit 61. The nozzle end 323 is configured to direct airflow pushing cotton away from a cotton harvesting unit such as for example from the second cotton drum 272 (shown in FIG. 9B and removed for ease of reference in FIGS. 7B and 8B) and into a respective duct system for conveying the harvested cotton to an accumulator or basket of the harvester vehicle.

As shown best in FIG. 8B, the nozzle end 320 of the first nozzle 220 is formed by a nozzle opening 340 disposed within the representative cotton picking unit 61 and located at or on the floor thereof. Similarly, the nozzle end 323 of the second nozzle 222 is formed by a nozzle opening disposed within the representative cotton picking unit 61 and located at or on the floor thereof. In this way, the first and second airflow paths 230, 232 created by the forced air exiting the openings 340 and 342 of the nozzle ends 320 and 323, respectively, in each of the picking units 61-66 may be directed generally from the front of each of the cotton picking units 61-66 and generally along the bottom floors thereof for helping to direct and motivate the harvested cotton generally towards the rear of cotton picking units 61-66 for gathering in a consolidated fashion within the ducts 71-76 and entrained in the first and second forced airflows 250, 252 within the ducts 71-76 for eventual conveyance to the crop storage receptacle 80 of the cotton harvester 15.

As shown best in FIG. 8B, the nozzle end 320 of the first nozzle 220 formed by the nozzle opening 340 disposed within the representative cotton picking unit 61 and located at or on the floor thereof defines a nozzle outlet 324. The nozzle end 323 of the second nozzle 222 formed by the nozzle opening 342 disposed within the representative cotton picking unit 61 and located at or on the floor thereof define a nozzle outlet 326.

In accordance with an example implementation, the nozzle outlet 324 defines an airflow outlet area that is larger than an airflow outlet area defined by the nozzle opening 342. In accordance with an example implementation, the airflow outlet area defined by the nozzle outlet 324 is in the range of five (5) to ten (10) times larger than the airflow outlet area defined by the nozzle opening 342. In accordance with a further example implementation, the airflow outlet area defined by the nozzle outlet 324 is about seven (7) times larger than the airflow outlet area defined by the nozzle opening 342.

In any of the implementations, the airflow outlet area defined by the nozzle outlet 324 together with the airflow outlet area defined by the nozzle opening 342 define a combined nozzle airflow outlet area, and the cotton flow accelerator 391 defines a cotton flow accelerator outlet area.

In any of the implementations, the combined nozzle airflow outlet area comprises a range of 60%-100% of the overall combined area defined by the nozzle airflow outlet area together with the cotton flow accelerator outlet area, and the cotton flow accelerator outlet area comprises a corresponding range of 40%-0% of the overall combined area defined by the nozzle airflow outlet area together with the cotton flow accelerator outlet area.

In any of the implementations, the combined nozzle airflow outlet area comprises 74% of the overall combined area defined by the nozzle airflow outlet area together with the cotton flow accelerator outlet area, and the cotton flow accelerator outlet area comprises a corresponding 26% of the overall combined area defined by the combined nozzle airflow outlet area together with the cotton flow accelerator outlet area.

In any of the implementations, the airflow flowing out from the nozzle outlet 324 together with the airflow flowing from the nozzle opening 342 comprises a range of 60%-100% of the airflow within the first air duct flowing to the crop storage receptacle of the cotton harvester, and the supplemental boost airflow comprises a corresponding range of 40%-0% of the airflow within the first air duct flowing from the cotton flow accelerator 390 to the crop storage receptacle of the cotton harvester.

In any of the implementations, the airflow flowing out from the nozzle outlet 324 together with the airflow flowing from the nozzle opening 342 comprises 74% of the airflow within the first air duct flowing to the crop storage receptacle of the cotton harvester, and the supplemental boost airflow comprises a corresponding 26% of the airflow within the first air duct flowing from the cotton flow accelerator 390 to the crop storage receptacle of the cotton harvester.

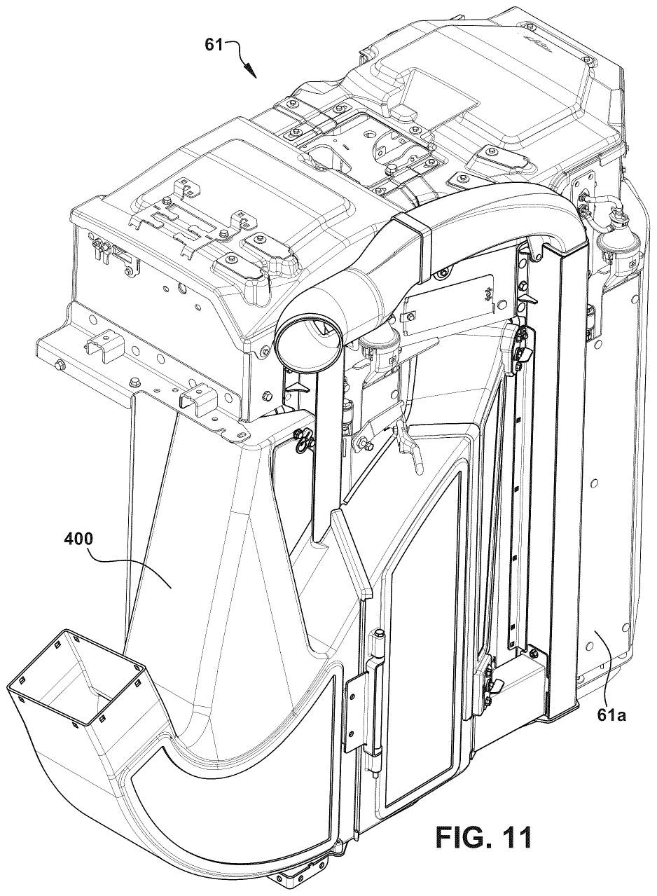

FIG. 11 is a perspective view of a first transition portion 400 of an air duct 71 (FIGS. 1-3) of the air duct system 70 attached with a housing 61a of a cotton picking unit 61 in accordance with an implementation. As shown there, the first transition portion 400 is operable to convey the first and second harvesting airflows 240, 242 (FIG. 5, and 7-9) exiting from the housing 61a of the cotton picking unit 61 to the air duct 71 of the air duct system 70 as the first and second forced airflows 250, 252 in accordance with an implementation. The first transition portion 400 in accordance with the example implementation is airtight and, accordingly, all of the first and second harvesting airflows 240, 242 (FIG. 5, and 7-9) exiting from the housing 61a of the cotton picking unit 61 is conveyed to the air duct 71 of the air duct system 70 as the first and second forced airflows 250, 252. Further in accordance with the example implementation the first transition portion 400 is airtight and, accordingly, no associated sources or methods that use suction and/or suction flow(s) are used or implemented for conveying the harvested cotton from the housing 61a of the cotton picking unit 61 to the cotton crop storage receptacle 80.

As shown in FIG. 11, the first transition portion 400 defines a gradual curve of an angle of about 45° relative to a vertical axis perpendicular to the bottom floor of the cotton picking unit 61. It is to be appreciated that the curve defined by the first transition portion 400 is selected in accordance with parameters that include an ability and/or efficiency of flowing harvested cotton entrained in the forced airflow therethrough and mechanical constraints relating to the physical construction of the cotton harvester 15.

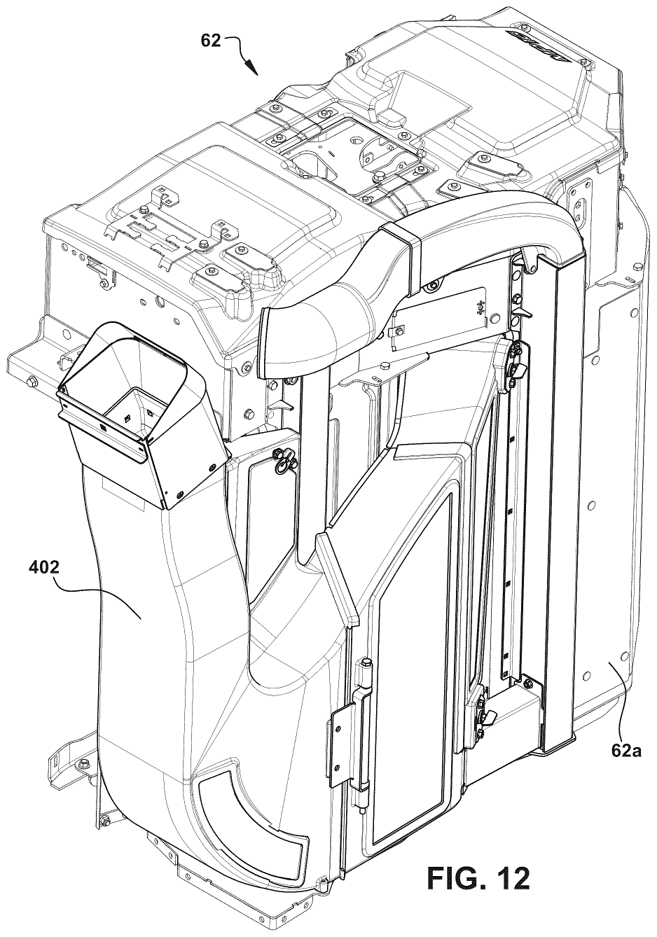

FIG. 12 is a perspective view of a second transition portion 402 of an air duct 72 (FIGS. 1-3) of the air duct system 70 attached with a housing 62a of a cotton picking unit 62 in accordance with an implementation. As shown there, the second transition portion 402 is operable to convey the first and second harvesting airflows 240, 242 (FIG. 5, and 7-9) exiting from the housing 62a of the cotton picking unit 62 to the air duct 72 of the air duct system 70 as the first and second forced airflows 250, 252 in accordance with an implementation. The second transition portion 402 in accordance with the example implementation is similarly airtight and, accordingly, all of the first and second harvesting airflows 240, 242 (FIG. 5, and 7-9) exiting from the housing 62a of the cotton picking unit 62 is conveyed to the air duct 72 of the air duct system 70 as the first and second forced airflows 250, 252. Further in accordance with the example implementation the second transition portion 402 is airtight and, accordingly, no associated sources or methods that use suction and/or suction flow(s) are used or implemented for conveying the harvested cotton from the housing 62a of the cotton picking unit 62 to the cotton crop storage receptacle 80.

As shown in FIG. 12, the second transition portion 402 defines a sharp, quick, or abrupt curve of an angle of about 90° relative to a plane defined by the bottom floor of the cotton picking unit 62. It is to be appreciated that the curve defined by the second transition portion 402 is selected in accordance with parameters that include an ability and/or efficiency of flowing harvested cotton entrained in the forced airflow therethrough and mechanical constraints relating to the physical construction of the cotton harvester 15.

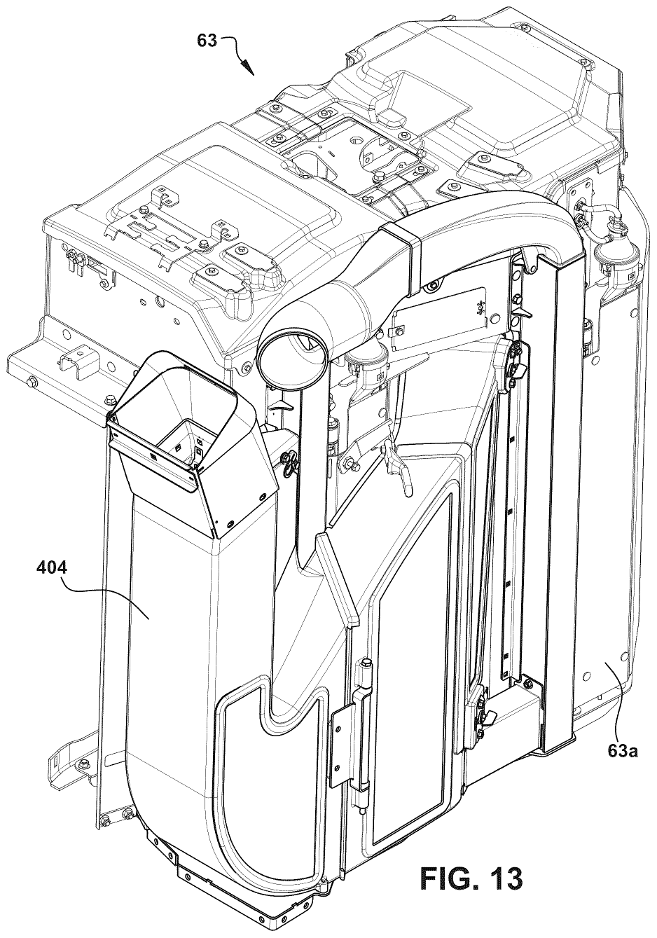

FIG. 13 is a perspective view of a third transition portion 404 of an air duct 73 (FIGS. 1-3) of the air duct system 70 attached with a housing 63a of a cotton picking unit 63 in accordance with an implementation. As shown there, the third transition portion 404 is operable to convey the first and second harvesting airflows 240, 242 (FIG. 5, and 7-9) exiting from the housing 63a of the cotton picking unit 63 to the air duct 73 of the air duct system 70 as the first and second forced airflows 250, 252 in accordance with an implementation. The third transition portion 403 in accordance with the example implementation is similarly airtight and, accordingly, all of the first and second harvesting airflows 240, 242 (FIG. 5, and 7-9) exiting from the housing 63a of the cotton picking unit 63 is conveyed to the air duct 73 of the air duct system 70 as the first and second forced airflows 250, 252. Further in accordance with the example implementation the third transition portion 403 is airtight and, accordingly, no associated sources or methods that use suction and/or suction flow(s) are used or implemented for conveying the harvested cotton from the housing 63a of the cotton picking unit 63 to the cotton crop storage receptacle 80.

As shown in FIG. 13, the third transition portion 403 defines a gradual curve of an angle of about 25° relative to a vertical axis perpendicular to the bottom floor of the cotton picking unit 63. It is to be appreciated that the curve defined by the third transition portion 404 is selected in accordance with parameters that include an ability and/or efficiency of flowing harvested cotton entrained in the forced airflow therethrough and mechanical constraints relating to the physical construction of the cotton harvester 15.

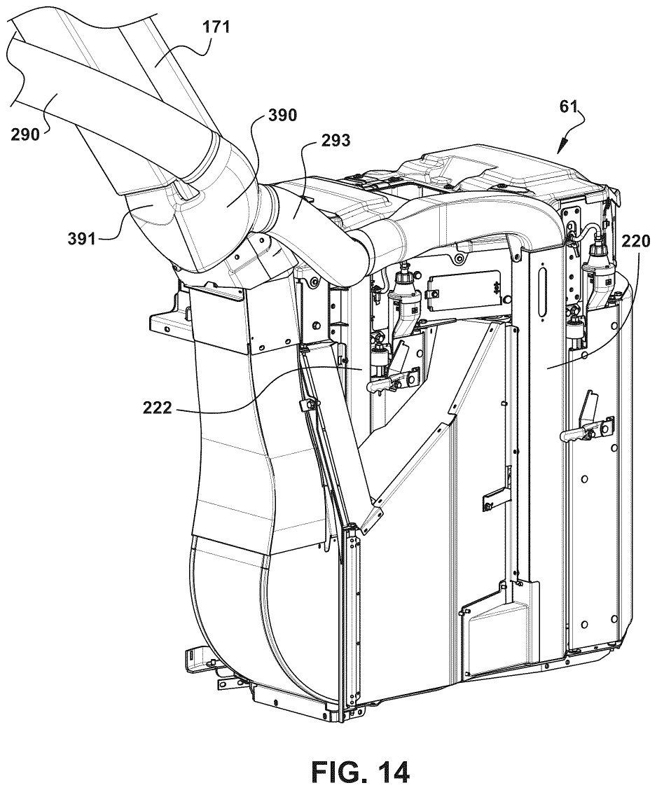

FIG. 14 is a perspective view of a portion of an air duct 71 attached with a housing of a cotton picking unit 61 in accordance with an implementation showing a cotton flow accelerator 390 configured to receive air from an associated air source such as for example from an airflow generator 210 (FIG. 3A) and having a boost nozzle end outlet 391 opening in the duct 71 of the system 70 to direct a supplemental boost airflow pushing the cotton within the duct system.

Any of the transition portions 400, 402, 404 described above may be used or otherwise implemented as desired or necessary between the air duct 71 of the air duct system 70 and the housing of the cotton picking unit 61 in accordance with the example implementations. As shown there, the first transition portion is operable to convey the first and second harvesting airflows 240, 242 (FIG. 5, and 7-9) exiting from the housing of the cotton picking unit 61 to the air duct 71 of the air duct system 70 as the first and second forced airflows 250, 252 in accordance with an implementation. The transition portion in accordance with the example implementation is airtight and, accordingly, all of the first and second harvesting airflows 240, 242 (FIG. 5, and 7-9) exiting from the housing of the cotton picking unit 61 is conveyed to the air duct 71 of the air duct system 70 as the first and second forced airflows 250, 252. Further in accordance with the example implementation the transition portion is airtight and, accordingly, no associated sources or methods that use suction and/or suction flow(s) are used or implemented for conveying the harvested cotton from the housing of the cotton picking unit 61 to the cotton crop storage receptacle 80.

As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

While the present disclosure has been illustrated and described in detail in the drawings and foregoing description, such illustration and description is not restrictive in character, it being understood that illustrative implementation(s) have been shown and described and that all changes and modifications that come within the spirit of the present disclosure are desired to be protected. Alternative implementations of the present disclosure may not include all of the features described yet still benefit from at least some of the advantages of such features. Those of ordinary skill in the art may devise their own implementations that incorporate one or more of the features of the present disclosure and fall within the spirit and scope of the appended claims.

What is claimed is:

1. A forced airflow cotton conveying system for a cotton harvester including a crop storage receptacle, the cotton conveying system comprising:
a first cotton picking unit operable to harvest cotton;
a first air duct coupled between the first cotton picking unit and the crop storage receptacle of the cotton harvester, wherein the first air duct provides an airtight seal between the first cotton picking unit and the crop storage receptacle of the cotton harvester;
an airflow generator operable to generate an airflow;
a first nozzle coupled between the airflow generator and the first cotton picking unit to form a first airflow path generating a first harvesting airflow within the first cotton picking unit and a first forced airflow within the first air duct coupled with the first cotton picking unit; and
a second nozzle coupled between the airflow generator and the first cotton picking unit to form a second airflow path generating a second harvesting airflow within the first cotton picking unit and a second forced airflow within the first air duct coupled with the first cotton picking unit,
wherein the first and second forced airflows combine within the first air duct to convey cotton harvested by the first cotton picking unit to the crop storage receptacle of the cotton harvester.

2. The forced airflow cotton conveying system according to claim 1, wherein the first air duct is under positive pressure for its full extent from the first cotton picking unit to the crop storage receptacle of the cotton harvester.

3. The forced airflow cotton conveying system according to claim 1, further comprising:
a first cotton conveying chute coupling the first nozzle with the first air duct and the first cotton picking unit, the first cotton conveying chute being located adjacent a front cotton drum of the first cotton picking unit; and
a second cotton conveying chute coupling the second nozzle with the first air duct and the first cotton picking unit, the second cotton conveying chute being located adjacent a rear cotton drum of the first cotton picking unit.

4. The forced airflow cotton conveying system according to claim 3, wherein:
the first cotton conveying chute is configured to direct the first forced airflow to the first air duct; and
the second cotton conveying chute is configured to direct the second forced airflows to the first air duct.

5. The forced airflow cotton conveying system according to claim 1, wherein:
the first nozzle is substantially “J” shaped; and
the second nozzle is substantially “J” shaped.

6. The forced airflow cotton conveying system according to claim 1, wherein:
the first nozzle comprises a first nozzle end disposed within a housing of the first cotton picking unit; and
the second nozzle comprises a pair of nozzle ends disposed within a housing of the first cotton picking unit.

7. The forced airflow cotton conveying system according to claim 6, wherein:
the first nozzle end is configured to direct airflow pushing harvested cotton away from a first cotton harvesting unit of the first cotton picking unit and into the first air duct for conveying the harvested cotton to the crop storage receptacle of the cotton harvester; and
the pair of nozzle ends are configured to direct airflow pushing the harvested cotton away from a second cotton harvesting unit of the first cotton picking unit and into the first air duct for conveying the harvested cotton to the crop storage receptacle of the cotton harvester.

8. The forced airflow cotton conveying system according to claim 7, wherein:
the pair of nozzle ends span a bottom end of the housing of the first cotton picking unit.

9. The forced airflow cotton conveying system according to claim 1, further comprising:
a “Y” shaped elbow having an inlet opening, a first outlet opening, and a second outlet opening, the first outlet opening being coupled with the first nozzle and the second outlet opening being coupled with the second nozzle; and
a hose coupled between the airflow generator and the inlet opening of the “Y” shaped elbow, the hose being operable to port the airflow generated by the airflow generator to the inlet opening of the “Y” shaped elbow and in turn to the first and second nozzles.

10. The forced airflow cotton conveying system according to claim 1, further comprising:
a transition portion attached with a housing of the first cotton picking unit, wherein the transition portion is operable to convey the first and second harvesting airflows, exiting from the housing of the first cotton picking unit to the first air duct of the air duct system as the first and second forced airflows.

11. A boosted forced airflow cotton conveying system for a cotton harvester including a crop storage receptacle, the boosted cotton conveying system comprising:
a first cotton picking unit operable to harvest cotton;
a first air duct coupled between the first cotton picking unit and the crop storage receptacle of the cotton harvester;
an airflow generator operable to generate an airflow;
a first cotton flow accelerator operably coupled with the first air duct, the first cotton flow accelerator being configured to receive air from the airflow generator via a first hose and comprising one or more boost nozzle end outlets opening in the first air duct to direct a supplemental boost airflow pushing the cotton within the duct system to help propel cotton harvested by the first cotton picking unit within the first air duct towards the crop storage receptacle using pressure of the supplemental boost airflow within the first air duct;
a first nozzle coupled between the airflow generator and the first cotton picking unit via a further hose to form a first airflow path generating a first harvesting airflow within the first cotton picking unit and a first forced airflow within the first air duct coupled with the first cotton picking unit; and
a second nozzle coupled between the airflow generator and the first cotton picking unit via the further hose to form a second airflow path generating a second harvesting airflow within the first cotton picking unit and a second forced airflow within the first air duct coupled with the first cotton picking unit,
wherein the first and second forced airflows combine together with the supplemental boost airflow within the first air duct to convey the cotton harvested by the first cotton picking unit to the crop storage receptacle of the cotton harvester,
wherein the first air duct is under positive pressure for its full extent from the first cotton picking unit to the crop storage receptacle of the cotton harvester.

12. The boosted forced airflow cotton conveying system according to claim 11, further comprising:
a first cotton conveying chute coupling the first nozzle with the first air duct and the first cotton picking unit, the first cotton conveying chute being located adjacent a front cotton drum of the first cotton picking unit; and
a second cotton conveying chute coupling the second nozzle with the first air duct and the first cotton picking unit, the second cotton conveying chute being located adjacent a rear cotton drum of the first cotton picking unit.

13. The boosted forced airflow cotton conveying system according to claim 12, wherein:
the first cotton conveying chute is configured to direct the first forced airflow to the first air duct; and
the second cotton conveying chute is configured to direct the second forced airflows to the first air duct.

14. The boosted forced airflow cotton conveying system according to claim 11, wherein:
the first nozzle is substantially “J” shaped; and
the second nozzle is substantially “J” shaped.

15. The boosted forced airflow cotton conveying system according to claim 11, wherein:
the first nozzle comprises a first nozzle end disposed within a housing of the first cotton picking unit; and
the second nozzle comprises a pair of nozzle ends disposed within a housing of the first cotton picking unit.

16. The boosted forced airflow cotton conveying system according to claim 15, wherein:
the first nozzle end is configured to direct airflow pushing harvested cotton away from a first cotton harvesting unit of the first cotton picking unit and into the first air duct for conveying the harvested cotton to the crop storage receptacle of the cotton harvester; and
the pair of nozzle ends are configured to direct airflow pushing the harvested cotton away from a second cotton harvesting unit of the first cotton picking unit and into the first air duct for conveying the harvested cotton to the crop storage receptacle of the cotton harvester.

17. The boosted forced airflow cotton conveying system according to claim 16, wherein:
the pair of nozzle ends span a bottom end of the housing of the first cotton picking unit.

18. The boosted forced airflow cotton conveying system according to claim 11, further comprising:
a “Y” shaped elbow having an inlet opening, a first outlet opening, and a second outlet opening, the first outlet opening being coupled with the first nozzle and the second outlet opening being coupled with the second nozzle; and
a hose coupled between the airflow generator and the inlet opening of the “Y” shaped elbow, the hose being operable to port the airflow generated by the airflow generator to the inlet opening of the “Y” shaped elbow and in turn to the first and second nozzles.

19. The boosted forced airflow cotton conveying system according to claim 11, further comprising:
a transition portion attached with a housing of the first cotton picking unit, wherein the transition portion is operable to convey the first and second harvesting airflows, exiting from the housing of the first cotton picking unit to the first air duct of the air duct system as the first and second forced airflows.

20. A forced airflow cotton conveying system for a cotton harvester including a crop storage receptacle, the boosted cotton conveying system comprising:
a first cotton picking unit operable to harvest cotton;
a first air duct coupled between the first cotton picking unit and the crop storage receptacle of the cotton harvester;
an airflow generator operable to generate an airflow;
a first cotton flow accelerator operably coupled with the first air duct, the cotton flow accelerator being configured to receive air from the airflow generator via a first hose and comprising one or more boost nozzle end outlets opening in the first air duct to direct a supplemental boost airflow pushing the cotton within the duct system to help propel cotton harvested by the first cotton picking unit within the first air duct towards the crop storage receptacle using pressure of the supplemental boost airflow within the first air duct;
a first nozzle coupled between the airflow generator and the first cotton picking unit via a further hose to form a first airflow path generating a first harvesting airflow within the first cotton picking unit and a first forced airflow within the first air duct coupled with the first cotton picking unit;
a second nozzle coupled between the airflow generator and the first cotton picking unit via the further hose to form a second airflow path generating a second harvesting airflow within the first cotton picking unit and a second forced airflow within the first air duct coupled with the first cotton picking unit,
a second cotton picking unit operable to harvest cotton;
a second air duct coupled between the second cotton picking unit and the crop storage receptacle of the cotton harvester, wherein the second air duct provides an airtight seal between the second cotton picking unit and the crop storage receptacle of the cotton harvester;
a further first nozzle coupled between the airflow generator and the second cotton picking unit to form a further first airflow path generating a further first harvesting airflow within the second cotton picking unit and a further first forced airflow within the second air duct coupled with the second cotton picking unit; and
a further second nozzle coupled between the airflow generator and the second cotton picking unit to form a further second airflow path generating a further second harvesting airflow within the second cotton picking unit and a further second forced airflow within the second air duct coupled with the second cotton picking unit,
wherein the first and second forced airflows combine together with the supplemental boost airflow within the first air duct to convey the cotton harvested by the first cotton picking unit to the crop storage receptacle of the cotton harvester,
wherein the first air duct is under positive pressure for its full extent from the first cotton picking unit to the crop storage receptacle of the cotton harvester,
wherein the first and second forced airflows combine within the first air duct to convey cotton harvested by the first cotton picking unit to the crop storage receptacle of the cotton harvester.
